(19) United States
(12) Patent Application Publication
(10) Pub. No.: US 2025/0324413 A1
(43) Pub. Date: Oct. 16, 2025

(54) CONFLICT RESOLUTION FOR SUBBAND FULL DUPLEX SYMBOLS

(71) Applicant: QUALCOMM Incorporated, San Diego, CA (US)

(72) Inventors: Muhammad Sayed Khairy ABDELGHAFFAR, San Jose, CA (US); Qian ZHANG, Basking Ridge, NJ (US)

(21) Appl. No.: 18/634,656

(22) Filed: Apr. 12, 2024

(51) Int. Cl. H04W 72/12; H04L 5/14

(52) U.S. Cl. CPC H04W 72/12; H04L 5/14

(57) ABSTRACT

Various aspects of the present disclosure generally relate to wireless communication. In some aspects, a user equipment (UE) may receive an indication of a first link direction for a subband full duplex (SBFD) resource, wherein the indication is via dynamic signaling or configuration information. The UE may perform a communication in the SBFD resource in association with a conflict between: the first link direction, and a conflicting communication in the SBFD resource having a second link direction different than the first link direction. Numerous other aspects are described.

### FIELD OF THE DISCLOSURE

Aspects of the present disclosure generally relate to wireless communication and specifically relate to techniques, apparatuses, and methods for conflict resolution for subband full duplex symbols.

### BACKGROUND

Wireless communication systems are widely deployed to provide various services that may include carrying voice, text, messaging, video, data, and/or other traffic. The services may include unicast, multicast, and/or broadcast services, among other examples. Typical wireless communication systems may employ multiple-access radio access technologies (RATs) capable of supporting communication with multiple users by sharing available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

The above multiple-access RATs have been adopted in various telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support Internet of things (IoT) and reduced capability device deployments, industrial connectivity, millimeter wave (mmWave) expansion, licensed and unlicensed spectrum access, non-terrestrial network (NTN) deployment, sidelink and other device-to-device direct communication technologies (for example, cellular vehicle-to-everything (CV2X) communication), massive multiple-input multiple-output (MIMO), disaggregated network architectures and network topology expansions, multiple-subscriber implementations, high-precision positioning, and/or radio frequency (RF) sensing, among other examples. As the demand for mobile broadband access continues to increase, further improvements in NR may be implemented, and other radio access technologies such as 6G may be introduced, to further advance mobile broadband evolution.

### SUMMARY

In some aspects, a method of wireless communication performed by a user equipment (UE) includes receiving an indication of a first link direction for a subband full duplex (SBFD) resource, wherein the indication is via dynamic signaling or configuration information; and performing a communication in the SBFD resource in association with a conflict between: the first link direction, and a conflicting communication in the SBFD resource having a second link direction different than the first link direction. In some aspects, the UE additionally receives one or more communications in the SBFD resource that is aligned with the first link direction and conflicting with the second link direction.

In some aspects, a method of wireless communication performed by a network node includes transmitting an indication of a first link direction for an SBFD resource, wherein the indication is via dynamic signaling or configuration information; and performing a communication in the SBFD resource in association with a conflict between: the first link direction, and a conflicting communication in the SBFD resource having a second link direction different than the first link direction.

In some aspects, an apparatus for wireless communication at a UE includes one or more memories; and one or more processors, coupled to the one or more memories, configured to cause the UE to: receive an indication of a first link direction for an SBFD resource, wherein the indication is via dynamic signaling or configuration information; and perform a communication in the SBFD resource in association with a conflict between: the first link direction, and a conflicting communication in the SBFD resource having a second link direction different than the first link direction. In some aspects, the UE additionally receives one or more communications in the SBFD resource that is aligned with the first link direction and conflicting with the second link direction.

In some aspects, an apparatus for wireless communication at a network node includes one or more memories; and one or more processors, coupled to the one or more memories, configured to cause the network node to: transmit an indication of a first link direction for an SBFD resource, wherein the indication is via dynamic signaling or configuration information; and perform a communication in the SBFD resource in association with a conflict between: the first link direction, and a conflicting communication in the SBFD resource having a second link direction different than the first link direction.

In some aspects, a non-transitory computer-readable medium storing a set of instructions for wireless communication includes one or more instructions that, when executed by one or more processors of a UE, cause the UE to: receive an indication of a first link direction for an SBFD resource, wherein the indication is via dynamic signaling or configuration information; and perform a communication in the SBFD resource in association with a conflict between: the first link direction, and a conflicting communication in the SBFD resource having a second link direction different than the first link direction.

In some aspects, a non-transitory computer-readable medium storing a set of instructions for wireless communication includes one or more instructions that, when executed by one or more processors of a network node, cause the network node to: transmit an indication of a first link direction for an SBFD resource, wherein the indication is via dynamic signaling or configuration information; and perform a communication in the SBFD resource in association with a conflict between: the first link direction, and a conflicting communication in the SBFD resource having a second link direction different than the first link direction.

In some aspects, an apparatus for wireless communication includes means for receiving an indication of a first link direction for an SBFD resource, wherein the indication is via dynamic signaling or configuration information; and means for performing a communication in the SBFD resource in association with a conflict between: the first link direction, and a conflicting communication in the SBFD resource having a second link direction different than the first link direction.

In some aspects, an apparatus for wireless communication includes means for transmitting an indication of a first link direction for an SBFD resource, wherein the indication is via dynamic signaling or configuration information; and means for performing a communication in the SBFD resource in association with a conflict between: the first link direction, and a conflicting communication in the SBFD resource having a second link direction different than the first link direction.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, the specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure, but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network in accordance with the present disclosure.

FIG. 2 is a diagram illustrating an example network node in communication with an example user equipment (UE) in a wireless network in accordance with the present disclosure.

FIG. 3 is a diagram illustrating an example disaggregated base station architecture in accordance with the present disclosure.

FIG. 4 is a diagram illustrating examples of full duplex communication in a wireless network, in accordance with the present disclosure.

FIG. 5A is a diagram illustrating examples of different duplexing modes, and FIG. 5B is a diagram illustrating an example of subband full duplex (SBFD) activation, in accordance with the present disclosure.

FIG. 6 is a diagram illustrating examples of SBFD operation and conflicting communications for an SBFD-aware UE, in accordance with the present disclosure.

FIG. 7 is a diagram illustrating an example of a partial overlap of a conflicting communication and an SBFD symbol, in accordance with the present disclosure.

FIG. 8 is a diagram illustrating an example of signaling associated with conflict resolution in SBFD symbols, in accordance with the present disclosure.

FIG. 9 is a diagram illustrating an example process performed, for example, at a UE or an apparatus of a UE, in accordance with the present disclosure.

FIG. 10 is a diagram illustrating an example process performed, for example, at a network node or an apparatus of a network node, in accordance with the present disclosure.

FIG. 11 is a diagram of an example apparatus for wireless communication, in accordance with the present disclosure.

FIG. 12 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms and is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

A radio access network (RAN) may support communications between user equipments (UEs) and network nodes (such as gNBs, distributed units, radio units, or the like). Communications from a UE to a network node may be referred to as uplink communications, and communications from a network node to a UE may be referred to as downlink communications. Uplink communications may occur on an uplink, and downlink communications may occur on a downlink. The downlink, or a downlink communication on the downlink, may be referred to as having or being associated with one link direction (e.g., a first link direction). The uplink, or an uplink communication on the uplink, may be referred to as having or being associated with another link direction (e.g., a second link direction). As used herein, “first link direction” and “second link direction” refer to different link directions, and not necessarily to specific link directions. For example, as used herein, a first link direction may be one of the downlink or the uplink, and a second link direction may be the other of the downlink or the uplink.

Some UEs or network nodes may support communication in only one link direction at a given time, which is referred to as half-duplex communication. A UE that supports or is capable of only half-duplex communication may be referred to as a half-duplex UE. Other UEs or network nodes may support simultaneous communication in two or more link directions, which is referred to as full duplex communication. One type of full duplex communication is subband full duplex (SBFD) communication, in which a communication bandwidth of a UE or a network node is divided into one or more downlink subbands (or more generally, subbands having a first link direction) and one or more uplink subbands (or more generally, subbands having a second link direction different than the first link direction).

SBFD communication can be supported at a network node, a UE, or both. A UE that can interpret signaling relating to SBFD communication (such as signaling that configures particular subbands or particular time resources to be SBFD resources in which SBFD communication is supported), and that is not capable of performing and/or not configured to perform SBFD communication, may be referred to as an SBFD aware UE. A UE that can interpret signaling related to SBFD communication, and that is capable of performing or configured to perform SBFD communication, may be referred to as an SBFD capable UE.

As mentioned, a network node may configure or select a time-domain resource, such as an orthogonal frequency division multiplexing (OFDM) symbol or a set of OFDM symbols, as an SBFD resource. An SBFD resource may include one or more uplink subbands and one or more downlink subbands. An SBFD aware UE may be capable of communicating in only one link direction at a time in an SBFD resource. Since an SBFD-aware UE may be capable of communicating in only one link direction at a time in an SBFD resource, the SBFD aware UE may identify the link direction, in the SBFD resource, in which the SBFD-aware UE may communicate. The SBFD aware UE may perform this determination according to explicit signaling from a network node (indicating that the UE is to perform only uplink communication or only downlink communication in the SBFD resource) or based on a rule and a set of configured or scheduled communications in the SBFD resource.

Difficulties may arise in configuring and implementing SBFD communication in SBFD resources. For example, network nodes may be expected to configure or schedule various types of communications in SBFD resources, which may include dynamically scheduled communications (such as communications scheduled by downlink control information (DCI)) and/or configured communications, such as configured reference signal transmissions, semi-persistent scheduled (SPS) communications, periodic reporting, or the like. A conflict may arise between a link direction of an SBFD resource, and a dynamically scheduled or configured communication in the SBFD resource. For example, this conflict may be due to a failure of (or a lack of expectation for) a scheduling or configuring network node to take into account the SBFD or non-SBFD status of resource slots when scheduling such communications. As another (non-exhaustive) example, this conflict may be due to prioritization of certain communications or resource configurations in the SBFD slots. Techniques for resolving such a conflict may be unclear. For example, assumptions about a reason for such a conflict may differ if the conflict is associated with an explicit indication of a resource as an SBFD resource, or associated with an identification of the symbol as an SBFD resource by the UE according to communications scheduled or configured in the SBFD resource. Furthermore, in some examples, one or more conflicting communications (having a different link direction than a link direction identified for an SBFD-aware UE in an SBFD resource) and one or more non-conflicting communications (that is, one or more communications that have the link direction identified for the SBFD-aware UE in the SBFD resource), and no rule or technique for resolving this conflict may be defined. Failure to resolve such conflicts may lead to inefficient spectral utilization, decreased throughput, and failure of communications in SBFD resources.

Aspects of the present disclosure relate generally to conflict resolution in SBFD resources. Some aspects more specifically relate to conflict resolution between a first link direction for an SBFD resource and a conflicting communication, having a second link direction, in the SBFD resource. In some aspects, the conflict resolution may be for an SBFD resource for which the first link direction is explicitly indicated. For example, the UE or the network node may apply a conflict resolution rule for explicit indication. In this example, the UE or the network node may drop the conflicting communication or scheduling information that schedules the conflicting communication. As another example, the UE or the network node may drop the conflicting communication and may perform another communication, in the SBFD resource, that does not conflict with the first link direction. In some aspects, the UE or the network node may identify a link direction for an SBFD symbol based on whether the link direction has been explicitly indicated to the UE. For example, if the link direction has been explicitly indicated, the UE may use the explicitly indicated link direction, and if the link direction has not been explicitly indicated, the UE may identify the link direction based on scheduled or configured communications in the SBFD symbol.

Aspects of the present disclosure may be used to realize one or more of the following potential advantages. In some aspects, by applying the conflict resolution for the SBFD resource for which the first link direction is explicitly indicated, aspects described herein provide conflict resolution specific to explicit indication, which may be beneficial because explicit indication may be associated with prioritization of certain link directions or communication. Thus, efficiency of spectral utilization may be increased, throughput may be increased, and failure of communications in SBFD slots may be reduced. By identifying a link direction for an SBFD symbol based on whether the link direction has been explicitly indicated to the UE, efficiency of signaling may be improved. For example, the network node may forgo providing an explicit indication where the UE can properly determine the link direction, and may override a baseline determination by providing an explicit indication.

Multiple-access radio access technologies (RATs) have been adopted in various telecommunication standards to provide common protocols that enable wireless communication devices to communicate on a municipal, enterprise, national, regional, or global level. For example, 5G New Radio (NR) is part of a continuous mobile broadband evolution promulgated by the Third Generation Partnership Project (3GPP). 5G NR supports various technologies and use cases including enhanced mobile broadband (eMBB), ultra-reliable low-latency communication (URLLC), massive machine-type communication (mMTC), millimeter wave (mmWave) technology, beamforming, network slicing, edge computing, Internet of Things (IoT) connectivity and management, and network function virtualization (NFV).

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, non-terrestrial network (NTN) deployments, disaggregated network architectures and network topology expansion, device aggregation, advanced duplex communication, sidelink and other device-to-device direct communication, IoT (including passive or ambient IoT) networks, reduced capability (RedCap) UE functionality, industrial connectivity, multiple-subscriber implementations, high-precision positioning, radio frequency (RF) sensing, and/or artificial intelligence or machine learning (AI/ML), among other examples. These technological improvements may support use cases such as wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples. The methods, operations, apparatuses, and techniques described herein may enable one or more of the foregoing technologies and/or support one or more of the foregoing use cases.

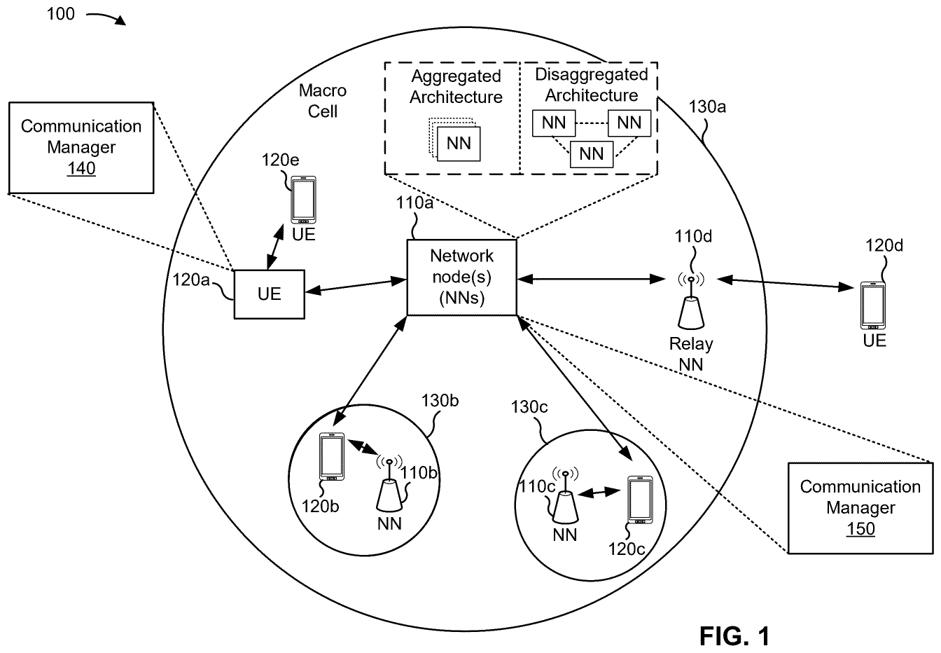

FIG. 1 is a diagram illustrating an example of a wireless communication network 100 in accordance with the present disclosure. The wireless communication network 100 may be or may include elements of a 5G (or NR) network or a 6G network, among other examples. The wireless communication network 100 may include multiple network nodes 110, shown as a network node (NN) 110a, a network node 110b, a network node 110c, and a network node 110d. The network nodes 110 may support communications with multiple UEs 120, shown as a UE 120a, a UE 120b, a UE 120c, a UE 120d, and a UE 120e.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHZ), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “Sub-6 GHZ” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into mid-band frequencies. Thus, “sub-6 GHZ,” if used herein, may broadly refer to frequencies that are less than 6 GHZ, that are within FR1, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR4a, FR4-1, FR4, and FR5 falls within the EHF band. In some examples, the wireless communication network 100 may implement dynamic spectrum sharing (DSS), in which multiple RATs (for example, 4G/LTE and 5G/NR) are implemented with dynamic bandwidth allocation (for example, based on user demand) in a single frequency band. It is contemplated that the frequencies included in these operating bands (for example, FR1, FR2, FR3, FR4, FR4-a, FR4-1, and/or FR5) may be modified, and techniques described herein may be applicable to those modified frequency ranges.

A network node 110 may include one or more devices, components, or systems that enable communication between a UE 120 and one or more devices, components, or systems of the wireless communication network 100. A network node 110 may be, may include, or may also be referred to as an NR network node, a 5G network node, a 6G network node, a Node B, an eNB, a gNB, an access point (AP), a transmission reception point (TRP), a mobility element, a core, a network entity, a network element, a network equipment, and/or another type of device, component, or system included in a radio access network (RAN).

A network node 110 may be implemented as a single physical node (for example, a single physical structure) or may be implemented as two or more physical nodes (for example, two or more distinct physical structures). For example, a network node 110 may be a device or system that implements part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node (having an aggregated architecture), meaning that the network node 110 may implement a full radio protocol stack that is physically and logically integrated within a single node (for example, a single physical structure) in the wireless communication network 100. For example, an aggregated network node 110 may consist of a single standalone base station or a single TRP that uses a full radio protocol stack to enable or facilitate communication between a UE 120 and a core network of the wireless communication network 100.

Alternatively, and as also shown, a network node 110 may be a disaggregated network node (sometimes referred to as a disaggregated base station), meaning that the network node 110 may implement a radio protocol stack that is physically distributed and/or logically distributed among two or more nodes in the same geographic location or in different geographic locations. For example, a disaggregated network node may have a disaggregated architecture. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 110 of the wireless communication network 100 may include one or more central units (CUs), one or more distributed units (DUs), and/or one or more radio units (RUs). A CU may host one or more higher layer control functions, such as radio resource control (RRC) functions, packet data convergence protocol (PDCP) functions, and/or service data adaptation protocol (SDAP) functions, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host one or more lower PHY layer functions, such as a fast Fourier transform (FFT), an inverse FFT (iFFT), beamforming, physical random access channel (PRACH) extraction and filtering, and/or scheduling of resources for one or more UEs 120, among other examples. An RU may host RF processing functions or lower PHY layer functions, such as an FFT, an iFFT, beamforming, or PRACH extraction and filtering, among other examples, according to a functional split, such as a lower layer functional split. In such an architecture, each RU can be operated to handle over the air (OTA) communication with one or more UEs 120.

In some aspects, a single network node 110 may include a combination of one or more CUs, one or more DUs, and/or one or more RUs. Additionally or alternatively, a network node 110 may include one or more Near-Real Time (Near-RT) RAN Intelligent Controllers (RICs) and/or one or more Non-Real Time (Non-RT) RICs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

Some network nodes 110 (for example, a base station, an RU, or a TRP) may provide communication coverage for a particular geographic area. In the 3GPP, the term “cell” can refer to a coverage area of a network node 110 or to a network node 110 itself, depending on the context in which the term is used. A network node 110 may support one or multiple (for example, three) cells. In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In some examples, a cell may not necessarily be stationary. For example, the geographic area of the cell may move according to the location of an associated mobile network node 110 (for example, a train, a satellite base station, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. In the example shown in FIG. 1, the network node 110a may be a macro network node for a macro cell 130a, the network node 110b may be a pico network node for a pico cell 130b, and the network node 110c may be a femto network node for a femto cell 130c. Various different types of network nodes 110 may generally transmit at different power levels, serve different coverage areas, and/or have different impacts on interference in the wireless communication network 100 than other types of network nodes 110. For example, macro network nodes may have a high transmit power level (for example, 5 to 40 watts), whereas pico network nodes, femto network nodes, and relay network nodes may have lower transmit power levels (for example, 0.1 to 2 watts).

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink channels may include one or more control channels and one or more data channels. A downlink control channel may be used to transmit downlink control information (DCI) (for example, scheduling information, reference signals, and/or configuration information) from a network node 110 to a UE 120. A downlink data channel may be used to transmit downlink data (for example, user data associated with a UE 120) from a network node 110 to a UE 120. Downlink control channels may include one or more physical downlink control channels (PDCCHs), and downlink data channels may include one or more physical downlink shared channels (PDSCHs). Uplink channels may similarly include one or more control channels and one or more data channels. An uplink control channel may be used to transmit uplink control information (UCI) (for example, reference signals and/or feedback corresponding to one or more downlink transmissions) from a UE 120 to a network node 110. An uplink data channel may be used to transmit uplink data (for example, user data associated with a UE 120) from a UE 120 to a network node 110. Uplink control channels may include one or more physical uplink control channels (PUCCHs), and uplink data channels may include one or more physical uplink shared channels (PUSCHs). The downlink and the uplink may each include a set of resources on which the network node 110 and the UE 120 may communicate.

Downlink and uplink resources may include time domain resources (frames, subframes, slots, and/or symbols), frequency domain resources (frequency bands, component carriers, subcarriers, resource blocks, and/or resource elements), and/or spatial domain resources (particular transmit directions and/or beam parameters). Frequency domain resources of some bands may be subdivided into bandwidth parts (BWPs). A BWP may be a continuous block of frequency domain resources (for example, a continuous block of resource blocks) that are allocated for one or more UEs 120. A UE 120 may be configured with both an uplink BWP and a downlink BWP (where the uplink BWP and the downlink BWP may be the same BWP or different BWPs). A BWP may be dynamically configured (for example, by a network node 110 transmitting a DCI configuration to the one or more UEs 120) and/or reconfigured, which means that a BWP can be adjusted in real-time (or near-real-time) based on changing network conditions in the wireless communication network 100 and/or based on the specific requirements of the one or more UEs 120. This enables more efficient use of the available frequency domain resources in the wireless communication network 100 because fewer frequency domain resources may be allocated to a BWP for a UE 120 (which may reduce the quantity of frequency domain resources that a UE 120 is required to monitor), leaving more frequency domain resources to be spread across multiple UEs 120. Thus, BWPs may also assist in the implementation of lower-capability UEs 120 by facilitating the configuration of smaller bandwidths for communication by such UEs 120.

As described above, in some aspects, the wireless communication network 100 may be, may include, or may be included in, an IAB network. In an IAB network, at least one network node 110 is an anchor network node that communicates with a core network. An anchor network node 110 may also be referred to as an IAB donor (or “IAB-donor”). The anchor network node 110 may connect to the core network via a wired backhaul link. For example, an Ng interface of the anchor network node 110 may terminate at the core network. Additionally or alternatively, an anchor network node 110 may connect to one or more devices of the core network that provide a core access and mobility management function (AMF). An IAB network also generally includes multiple non-anchor network nodes 110, which may also be referred to as relay network nodes or simply as IAB nodes (or “IAB-nodes”). Each non-anchor network node 110 may communicate directly with the anchor network node 110 via a wireless backhaul link to access the core network, or may communicate indirectly with the anchor network node 110 via one or more other non-anchor network nodes 110 and associated wireless backhaul links that form a backhaul path to the core network. Some anchor network node 110 or other non-anchor network node 110 may also communicate directly with one or more UEs 120 via wireless access links that carry access traffic. In some examples, network resources for wireless communication (such as time resources, frequency resources, and/or spatial resources) may be shared between access links and backhaul links.

In some examples, any network node 110 that relays communications may be referred to as a relay network node, a relay station, or simply as a relay. A relay may receive a transmission of a communication from an upstream station (for example, another network node 110 or a UE 120) and transmit the communication to a downstream station (for example, a UE 120 or another network node 110). In this case, the wireless communication network 100 may include or be referred to as a “multi-hop network.” In the example shown in FIG. 1, the network node 110d (for example, a relay network node) may communicate with the network node 110a (for example, a macro network node) and the UE 120d in order to facilitate communication between the network node 110a and the UE 120d. Additionally or alternatively, a UE 120 may be or may operate as a relay station that can relay transmissions to or from other UEs 120. A UE 120 that relays communications may be referred to as a UE relay or a relay UE, among other examples.

The UEs 120 may be physically dispersed throughout the wireless communication network 100, and each UE 120 may be stationary or mobile. A UE 120 may be, may include, or may be included in an access terminal, another terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, and/or smart jewelry, such as a smart ring or a smart bracelet), an entertainment device (for example, a music device, a video device, and/or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

A UE 120 and/or a network node 110 may include one or more chips, system-on-chips (SoCs), chipsets, packages, or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The UE 120 may include or may be included in a housing that houses components associated with the UE 120 including the processing system.

Some UEs 120 may be considered machine-type communication (MTC) UEs, evolved or enhanced machine-type communication (eMTC), UEs, further enhanced eMTC (feMTC) UEs, or enhanced feMTC (efeMTC) UEs, or further evolutions thereof, all of which may be simply referred to as “MTC UEs”). An MTC UE may be, may include, or may be included in or coupled with a robot, an uncrewed aerial vehicle, a remote device, a sensor, a meter, a monitor, and/or a location tag. Some UEs 120 may be considered IoT devices and/or may be implemented as NB-IoT (narrowband IoT) devices. An IoT UE or NB-IoT device may be, may include, or may be included in or coupled with an industrial machine, an appliance, a refrigerator, a doorbell camera device, a home automation device, and/or a light fixture, among other examples. Some UEs 120 may be considered Customer Premises Equipment, which may include telecommunications devices that are installed at a customer location (such as a home or office) to enable access to a service provider's network (such as included in or in communication with the wireless communication network 100).

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, enhanced mobile broadband (eMBB), and/or precise positioning in the wireless communication network 100, among other examples. A third category of UEs 120 may have mid-tier complexity and/or capability (for example, a capability between UEs 120 of the first category and UEs 120 of the second capability). A UE 120 of the third category may be referred to as a reduced capacity UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, and/or cameras that are associated with a limited bandwidth, power capacity, and/or transmission range, among other examples. RedCap UEs may support healthcare environments, building automation, electrical distribution, process automation, transport and logistics, and/or smart city deployments, among other examples.

In some examples, two or more UEs 120 (for example, shown as UE 120a and UE 120e) may communicate directly with one another using sidelink communications (for example, without communicating by way of a network node 110 as an intermediary). As an example, the UE 120a may directly transmit data, control information, or other signaling as a sidelink communication to the UE 120e. This is in contrast to, for example, the UE 120a first transmitting data in an UL communication to a network node 110, which then transmits the data to the UE 120e in a DL communication. In various examples, the UEs 120 may transmit and receive sidelink communications using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols. In some deployments and configurations, a network node 110 may schedule and/or allocate resources for sidelink communications between UEs 120 in the wireless communication network 100. In some other deployments and configurations, a UE 120 (instead of a network node 110) may perform, or collaborate or negotiate with one or more other UEs to perform, scheduling operations, resource selection operations, and/or other operations for sidelink communications.

In various examples, some of the network nodes 110 and the UEs 120 of the wireless communication network 100 may be configured for full duplex operation in addition to half-duplex operation. A network node 110 or a UE 120 operating in a half-duplex mode may perform only one of transmission or reception during particular time resources, such as during particular slots, symbols, or other time periods. Half-duplex operation may involve time-division duplexing (TDD), in which DL transmissions of the network node 110 and UL transmissions of the UE 120 do not occur in the same time resources (that is, the transmissions do not overlap in time). In contrast, a network node 110 or a UE 120 operating in a full duplex mode can transmit and receive communications concurrently (for example, in the same time resources). By operating in a full duplex mode, network nodes 110 and/or UEs 120 may generally increase the capacity of the network and the radio access link. In some examples, full duplex operation may involve frequency-division duplexing (FDD), in which DL transmissions of the network node 110 are performed in a first frequency band or on a first component carrier and transmissions of the UE 120 are performed in a second frequency band or on a second component carrier different than the first frequency band or the first component carrier, respectively. In some examples, full duplex operation may be enabled for a UE 120 but not for a network node 110. For example, a UE 120 may simultaneously transmit an UL transmission to a first network node 110 and receive a DL transmission from a second network node 110 in the same time resources. In some other examples, full duplex operation may be enabled for a network node 110 but not for a UE 120. For example, a network node 110 may simultaneously transmit a DL transmission to a first UE 120 and receive an UL transmission from a second UE 120 in the same time resources. In some other examples, full duplex operation may be enabled for both a network node 110 and a UE 120.

In some examples, the UEs 120 and the network nodes 110 may perform MIMO communication. “MIMO” generally refers to transmitting or receiving multiple signals (such as multiple layers or multiple data streams) simultaneously over the same time and frequency resources. MIMO techniques generally exploit multipath propagation. MIMO may be implemented using various spatial processing or spatial multiplexing operations. In some examples, MIMO may support simultaneous transmission to multiple receivers, referred to as multi-user MIMO (MU-MIMO). Some RATs may employ advanced MIMO techniques, such as mTRP operation (including redundant transmission or reception on multiple TRPs), reciprocity in the time domain or the frequency domain, single-frequency-network (SFN) transmission, or non-coherent joint transmission (NC-JT).

In some aspects, the UE 120 may include a communication manager 140. As described in more detail elsewhere herein, the communication manager 140 may receive an indication of a first link direction for an SBFD resource, wherein the indication is via dynamic signaling or configuration information; and perform a communication in the SBFD resource in association with a conflict between: the first link direction, and a conflicting communication in the SBFD resource having a second link direction different than the first link direction. Additionally, or alternatively, the communication manager 140 may perform one or more other operations described herein.

In some aspects, the network node 110 may include a communication manager 150. As described in more detail elsewhere herein, the communication manager 150 may transmit an indication of a first link direction for an SBFD resource, wherein the indication is via dynamic signaling or configuration information; and perform a communication in the SBFD resource in association with a conflict between: the first link direction, and a conflicting communication in the SBFD resource having a second link direction different than the first link direction. Additionally, or alternatively, the communication manager 150 may perform one or more other operations described herein.

As indicated above, FIG. 1 is provided as an example. Other examples may differ from what is described with regard to FIG. 1.

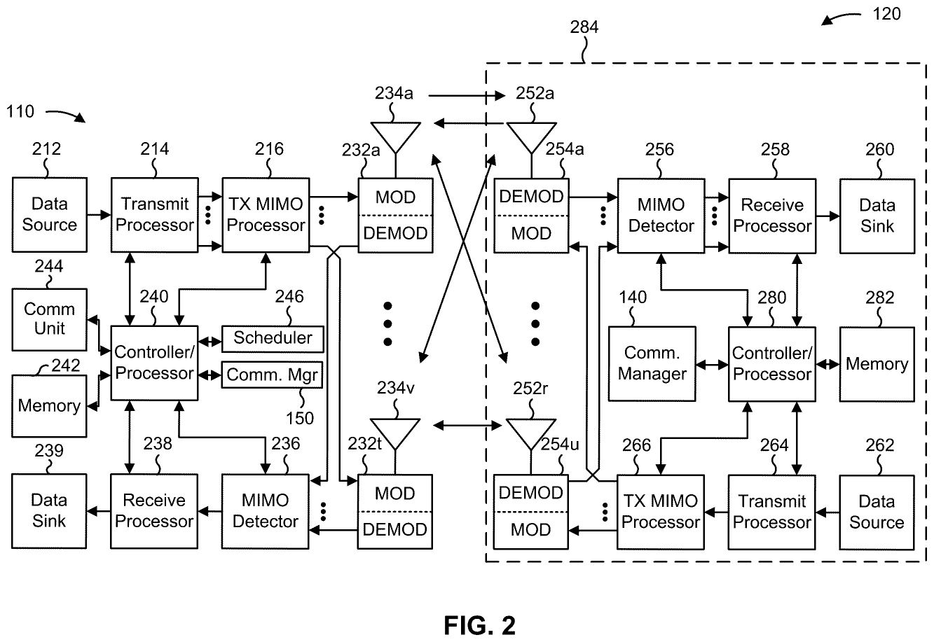

FIG. 2 is a diagram illustrating an example network node 110 in communication with an example UE 120 in a wireless network in accordance with the present disclosure.

As shown in FIG. 2, the network node 110 may include a data source 212, a transmit processor 214, a transmit (TX) MIMO processor 216, a set of modems 232 (shown as 232a through 232t, where t≥1), a set of antennas 234 (shown as 234a through 234v, where v≥1), a MIMO detector 236, a receive processor 238, a data sink 239, a controller/processor 240, a memory 242, a communication unit 244, a scheduler 246, and/or a communication manager 150, among other examples. In some configurations, one or a combination of the antenna(s) 234, the modem(s) 232, the MIMO detector 236, the receive processor 238, the transmit processor 214, and/or the TX MIMO processor 216 may be included in a transceiver of the network node 110. The transceiver may be under control of and used by one or more processors, such as the controller/processor 240, and in some aspects in conjunction with processor-readable code stored in the memory 242, to perform aspects of the methods, processes, and/or operations described herein. In some aspects, the network node 110 may include one or more interfaces, communication components, and/or other components that facilitate communication with the UE 120 or another network node.

The terms “processor,” “controller,” or “controller/processor” may refer to one or more controllers and/or one or more processors. For example, reference to “a/the processor,” “a/the controller/processor,” or the like (in the singular) should be understood to refer to any one or more of the processors described in connection with FIG. 2, such as a single processor or a combination of multiple different processors. Reference to “one or more processors” should be understood to refer to any one or more of the processors described in connection with FIG. 2. For example, one or more processors of the network node 110 may include transmit processor 214, TX MIMO processor 216, MIMO detector 236, receive processor 238, and/or controller/processor 240. Similarly, one or more processors of the UE 120 may include MIMO detector 256, receive processor 258, transmit processor 264, TX MIMO processor 266, and/or controller/processor 280.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 2. For example, operation described as being performed by one or more memories can be performed by the same subset of the one or more memories or different subsets of the one or more memories.

For downlink communication from the network node 110 to the UE 120, the transmit processor 214 may receive data (“downlink data”) intended for the UE 120 (or a set of UEs that includes the UE 120) from the data source 212 (such as a data pipeline or a data queue). In some examples, the transmit processor 214 may select one or more MCSs for the UE 120 in accordance with one or more channel quality indicators (CQIs) received from the UE 120. The network node 110 may process the data (for example, including encoding the data) for transmission to the UE 120 on a downlink in accordance with the MCS(s) selected for the UE 120 to generate data symbols. The transmit processor 214 may process system information (for example, semi-static resource partitioning information (SRPI)) and/or control information (for example, CQI requests, grants, and/or upper layer signaling) and provide overhead symbols and/or control symbols. The transmit processor 214 may generate reference symbols for reference signals (for example, a cell-specific reference signal (CRS), a demodulation reference signal (DMRS), or a channel state information (CSI) reference signal (CSI-RS)) and/or synchronization signals (for example, a primary synchronization signal (PSS) or a secondary synchronization signals (SSS)).

The TX MIMO processor 216 may perform spatial processing (for example, precoding) on the data symbols, the control symbols, the overhead symbols, and/or the reference symbols, if applicable, and may provide a set of output symbol streams (for example, T output symbol streams) to the set of modems 232. For example, each output symbol stream may be provided to a respective modulator component (shown as MOD) of a modem 232. Each modem 232 may use the respective modulator component to process (for example, to modulate) a respective output symbol stream (for example, for orthogonal frequency division multiplexing (OFDM)) to obtain an output sample stream. Each modem 232 may further use the respective modulator component to process (for example, convert to analog, amplify, filter, and/or upconvert) the output sample stream to obtain a time domain downlink signal. The modems 232a through 232t may together transmit a set of downlink signals (for example, T downlink signals) via the corresponding set of antennas 234.

A downlink signal may include a DCI communication, a MAC control element (MAC-CE) communication, an RRC communication, a downlink reference signal, or another type of downlink communication. Downlink signals may be transmitted on a PDCCH, a PDSCH, and/or on another downlink channel. A downlink signal may carry one or more transport blocks (TBs) of data. A TB may be a unit of data that is transmitted over an air interface in the wireless communication network 100. A data stream (for example, from the data source 212) may be encoded into multiple TBs for transmission over the air interface. The quantity of TBs used to carry the data associated with a particular data stream may be associated with a TB size common to the multiple TBs. The TB size may be based on or otherwise associated with radio channel conditions of the air interface, the MCS used for encoding the data, the downlink resources allocated for transmitting the data, and/or another parameter. In general, the larger the TB size, the greater the amount of data that can be transmitted in a single transmission, which reduces signaling overhead. However, larger TB sizes may be more prone to transmission and/or reception errors than smaller TB sizes, but such errors may be mitigated by more robust error correction techniques.

For uplink communication from the UE 120 to the network node 110, uplink signals from the UE 120 may be received by an antenna 234, may be processed by a modem 232 (for example, a demodulator component, shown as DEMOD, of a modem 232), may be detected by the MIMO detector 236 (for example, a receive (Rx) MIMO processor) if applicable, and/or may be further processed by the receive processor 238 to obtain decoded data and/or control information. The receive processor 238 may provide the decoded data to a data sink 239 (which may be a data pipeline, a data queue, and/or another type of data sink) and provide the decoded control information to a processor, such as the controller/processor 240.

The network node 110 may use the scheduler 246 to schedule one or more UEs 120 for downlink or uplink communications. In some aspects, the scheduler 246 may use DCI to dynamically schedule DL transmissions to the UE 120 and/or UL transmissions from the UE 120. In some examples, the scheduler 246 may allocate recurring time domain resources and/or frequency domain resources that the UE 120 may use to transmit and/or receive communications using an RRC configuration (for example, a semi-static configuration), for example, to perform semi-persistent scheduling (SPS) or to configure a configured grant (CG) for the UE 120.

One or more of the transmit processor 214, the TX MIMO processor 216, the modem 232, the antenna 234, the MIMO detector 236, the receive processor 238, and/or the controller/processor 240 may be included in an RF chain of the network node 110. An RF chain may include one or more filters, mixers, oscillators, amplifiers, analog-to-digital converters (ADCs), and/or other devices that convert between an analog signal (such as for transmission or reception via an air interface) and a digital signal (such as for processing by one or more processors of the network node 110). In some aspects, the RF chain may be or may be included in a transceiver of the network node 110.

In some examples, the network node 110 may use the communication unit 244 to communicate with a core network and/or with other network nodes. The communication unit 244 may support wired and/or wireless communication protocols and/or connections, such as Ethernet, optical fiber, common public radio interface (CPRI), and/or a wired or wireless backhaul, among other examples. The network node 110 may use the communication unit 244 to transmit and/or receive data associated with the UE 120 or to perform network control signaling, among other examples. The communication unit 244 may include a transceiver and/or an interface, such as a network interface.

The UE 120 may include a set of antennas 252 (shown as antennas 252a through 252r, where r≥1), a set of modems 254 (shown as modems 254a through 254u, where u≥1), a MIMO detector 256, a receive processor 258, a data sink 260, a data source 262, a transmit processor 264, a TX MIMO processor 266, a controller/processor 280, a memory 282, and/or a communication manager 140, among other examples. One or more of the components of the UE 120 may be included in a housing 284. In some aspects, one or a combination of the antenna(s) 252, the modem(s) 254, the MIMO detector 256, the receive processor 258, the transmit processor 264, or the TX MIMO processor 266 may be included in a transceiver that is included in the UE 120. The transceiver may be under control of and used by one or more processors, such as the controller/processor 280, and in some aspects in conjunction with processor-readable code stored in the memory 282, to perform aspects of the methods, processes, or operations described herein. In some aspects, the UE 120 may include another interface, another communication component, and/or another component that facilitates communication with the network node 110 and/or another UE 120.

For downlink communication from the network node 110 to the UE 120, the set of antennas 252 may receive the downlink communications or signals from the network node 110 and may provide a set of received downlink signals (for example, R received signals) to the set of modems 254. For example, each received signal may be provided to a respective demodulator component (shown as DEMOD) of a modem 254. Each modem 254 may use the respective demodulator component to condition (for example, filter, amplify, downconvert, and/or digitize) a received signal to obtain input samples. Each modem 254 may use the respective demodulator component to further demodulate or process the input samples (for example, for OFDM) to obtain received symbols. The MIMO detector 256 may obtain received symbols from the set of modems 254, may perform MIMO detection on the received symbols if applicable, and may provide detected symbols. The receive processor 258 may process (for example, decode) the detected symbols, may provide decoded data for the UE 120 to the data sink 260 (which may include a data pipeline, a data queue, and/or an application executed on the UE 120), and may provide decoded control information and system information to the controller/processor 280.

For uplink communication from the UE 120 to the network node 110, the transmit processor 264 may receive and process data (“uplink data”) from a data source 262 (such as a data pipeline, a data queue, and/or an application executed on the UE 120) and control information from the controller/processor 280. The control information may include one or more parameters, feedback, one or more signal measurements, and/or other types of control information. In some aspects, the receive processor 258 and/or the controller/processor 280 may determine, for a received signal (such as received from the network node 110 or another UE), one or more parameters relating to transmission of the uplink communication. The one or more parameters may include a reference signal received power (RSRP) parameter, a received signal strength indicator (RSSI) parameter, a reference signal received quality (RSRQ) parameter, a CQI parameter, or a transmit power control (TPC) parameter, among other examples. The control information may include an indication of the RSRP parameter, the RSSI parameter, the RSRQ parameter, the CQI parameter, the TPC parameter, and/or another parameter. The control information may facilitate parameter selection and/or scheduling for the UE 120 by the network node 110.

The transmit processor 264 may generate reference symbols for one or more reference signals, such as an uplink DMRS, an uplink sounding reference signal (SRS), and/or another type of reference signal. The symbols from the transmit processor 264 may be precoded by the TX MIMO processor 266, if applicable, and further processed by the set of modems 254 (for example, for DFT-s-OFDM or CP-OFDM). The TX MIMO processor 266 may perform spatial processing (for example, precoding) on the data symbols, the control symbols, the overhead symbols, and/or the reference symbols, if applicable, and may provide a set of output symbol streams (for example, U output symbol streams) to the set of modems 254. For example, each output symbol stream may be provided to a respective modulator component (shown as MOD) of a modem 254. Each modem 254 may use the respective modulator component to process (for example, to modulate) a respective output symbol stream (for example, for OFDM) to obtain an output sample stream. Each modem 254 may further use the respective modulator component to process (for example, convert to analog, amplify, filter, and/or upconvert) the output sample stream to obtain an uplink signal.

The modems 254a through 254u may transmit a set of uplink signals (for example, R uplink signals or U uplink symbols) via the corresponding set of antennas 252. An uplink signal may include a UCI communication, a MAC-CE communication, an RRC communication, or another type of uplink communication. Uplink signals may be transmitted on a PUSCH, a PUCCH, and/or another type of uplink channel. An uplink signal may carry one or more TBs of data. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

One or more antennas of the set of antennas 252 or the set of antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 234 or an antenna 252 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range.

The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal. In some implementations, antenna elements may be individually selected or deselected for directional transmission of a signal (or signals) by controlling amplitudes of one or more corresponding amplifiers and/or phases of the signal(s) to form one or more beams. The shape of a beam (such as the amplitude, width, and/or presence of side lobes) and/or the direction of a beam (such as an angle of the beam relative to a surface of an antenna array) can be dynamically controlled by modifying the phase shifts, phase offsets, and/or amplitudes of the multiple signals relative to each other.

Different UEs 120 or network nodes 110 may include different numbers of antenna elements. For example, a UE 120 may include a single antenna element, two antenna elements, four antenna elements, eight antenna elements, or a different number of antenna elements. As another example, a network node 110 may include eight antenna elements, 24 antenna elements, 64 antenna elements, 128 antenna elements, or a different number of antenna elements. Generally, a larger number of antenna elements may provide increased control over parameters for beam generation relative to a smaller number of antenna elements, whereas a smaller number of antenna elements may be less complex to implement and may use less power than a larger number of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

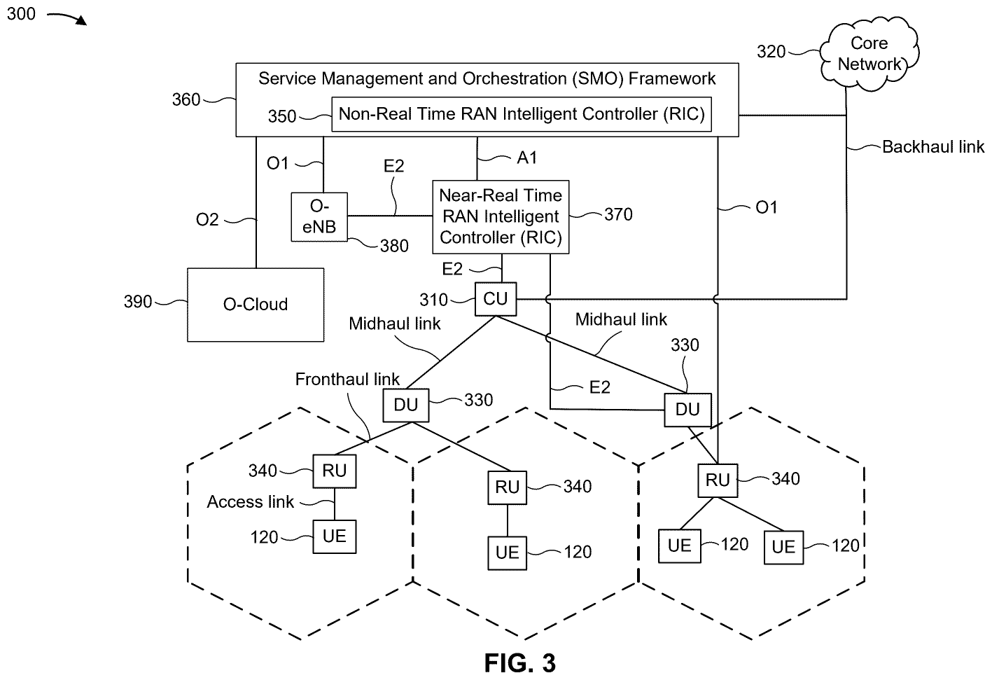

FIG. 3 is a diagram illustrating an example disaggregated base station architecture 300 in accordance with the present disclosure. One or more components of the example disaggregated base station architecture 300 may be, may include, or may be included in one or more network nodes (such one or more network nodes 110). The disaggregated base station architecture 300 may include a CU 310 that can communicate directly with a core network 320 via a backhaul link, or that can communicate indirectly with the core network 320 via one or more disaggregated control units, such as a Non-RT RIC 350 associated with a Service Management and Orchestration (SMO) Framework 360 and/or a Near-RT RIC 370 (for example, via an E2 link). The CU 310 may communicate with one or more DUs 330 via respective midhaul links, such as via F1 interfaces. Each of the DUs 330 may communicate with one or more RUs 340 via respective fronthaul links. Each of the RUs 340 may communicate with one or more UEs 120 via respective RF access links. In some deployments, a UE 120 may be simultaneously served by multiple RUs 340.

Each of the components of the disaggregated base station architecture 300, including the CUS 310, the DUs 330, the RUs 340, the Near-RT RICs 370, the Non-RT RICs 350, and the SMO Framework 360, may include one or more interfaces or may be coupled with one or more interfaces for receiving or transmitting signals, such as data or information, via a wired or wireless transmission medium.

In some aspects, the CU 310 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 310 may be deployed to communicate with one or more DUs 330, as necessary, for network control and signaling. Each DU 330 may correspond to a logical unit that includes one or more base station functions to control the operation of one or more RUs 340. For example, a DU 330 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 330, or for communicating signals with the control functions hosted by the CU 310. Each RU 340 may implement lower layer functionality. In some aspects, real-time and non-real-time aspects of control and user plane communication with the RU(s) 340 may be controlled by the corresponding DU 330.

The SMO Framework 360 may support RAN deployment and provisioning of non-virtualized and virtualized network elements. For non-virtualized network elements, the SMO Framework 360 may support the deployment of dedicated physical resources for RAN coverage requirements, which may be managed via an operations and maintenance interface, such as an O1 interface. For virtualized network elements, the SMO Framework 360 may interact with a cloud computing platform (such as an open cloud (O-Cloud) platform 390) to perform network element life cycle management (such as to instantiate virtualized network elements) via a cloud computing platform interface, such as an O2 interface. A virtualized network element may include, but is not limited to, a CU 310, a DU 330, an RU 340, a non-RT RIC 350, and/or a Near-RT RIC 370. In some aspects, the SMO Framework 360 may communicate with a hardware aspect of a 4G RAN, a 5G NR RAN, and/or a 6G RAN, such as an open eNB (O-eNB) 380, via an O1 interface. Additionally or alternatively, the SMO Framework 360 may communicate directly with each of one or more RUs 340 via a respective O1 interface. In some deployments, this configuration can enable each DU 330 and the CU 310 to be implemented in a cloud-based RAN architecture, such as a vRAN architecture.

The Non-RT RIC 350 may include or may implement a logical function that enables non-real-time control and optimization of RAN elements and resources, AI/ML workflows including model training and updates, and/or policy-based guidance of applications and/or features in the Near-RT RIC 370. The Non-RT RIC 350 may be coupled to or may communicate with (such as via an A1 interface) the Near-RT RIC 370. The Near-RT RIC 370 may include or may implement a logical function that enables near-real-time control and optimization of RAN elements and resources via data collection and actions via an interface (such as via an E2 interface) connecting one or more CUs 310, one or more DUs 330, and/or an O-eNB with the Near-RT RIC 370.

In some aspects, to generate AI/ML models to be deployed in the Near-RT RIC 370, the Non-RT RIC 350 may receive parameters or external enrichment information from external servers. Such information may be utilized by the Near-RT RIC 370 and may be received at the SMO Framework 360 or the Non-RT RIC 350 from non-network data sources or from network functions. In some examples, the Non-RT RIC 350 or the Near-RT RIC 370 may tune RAN behavior or performance. For example, the Non-RT RIC 350 may monitor long-term trends and patterns for performance and may employ AI/ML models to perform corrective actions via the SMO Framework 360 (such as reconfiguration via an O1 interface) or via creation of RAN management policies (such as A1 interface policies).

As indicated above, FIG. 3 is provided as an example. Other examples may differ from what is described with regard to FIG. 3.

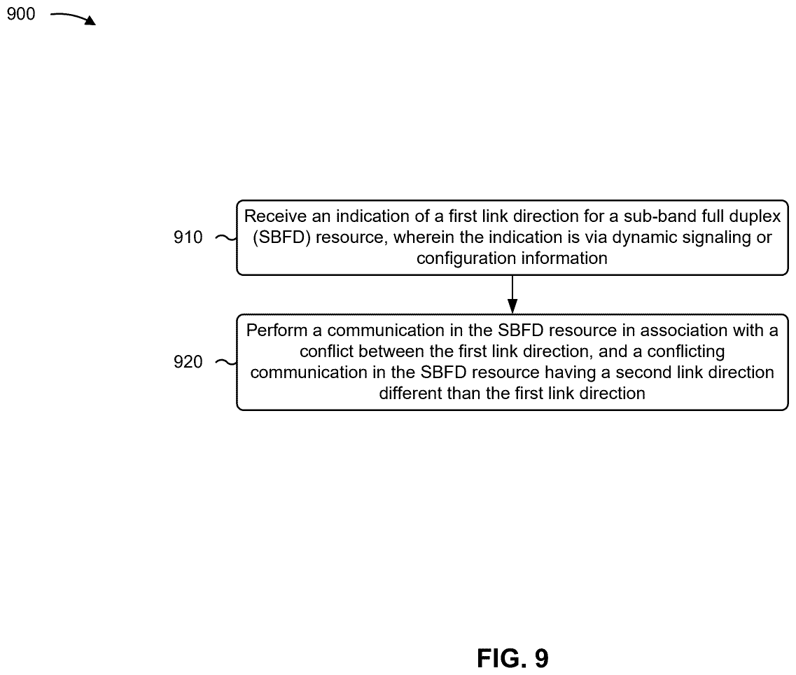

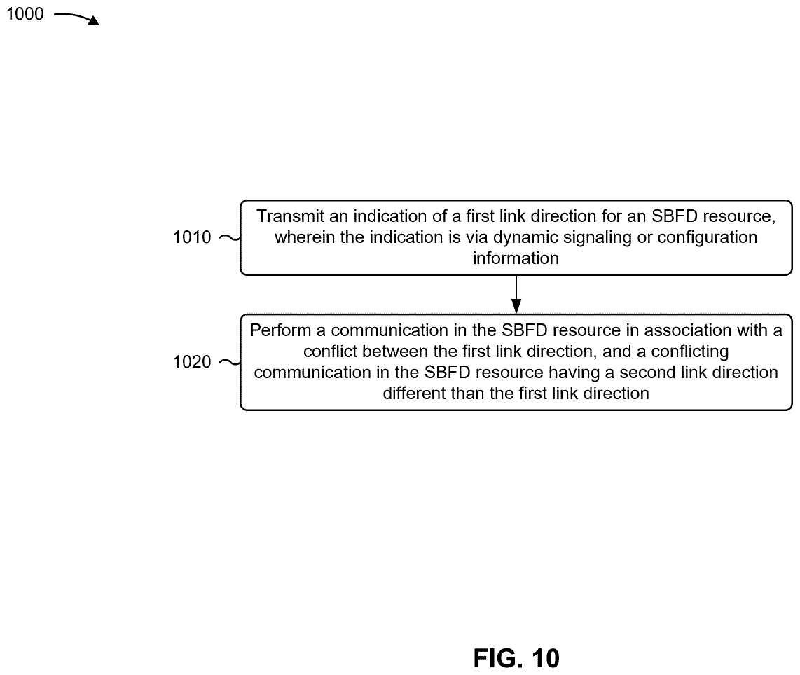

The network node 110, the controller/processor 240 of the network node 110, the UE 120, the controller/processor 280 of the UE 120, the CU 310, the DU 330, the RU 340, or any other component(s) of FIG. 1, 2, or 3 may implement one or more techniques or perform one or more operations associated with conflict resolution for SBFD resources, as described in more detail elsewhere herein. For example, the controller/processor 240 of the network node 110, the controller/processor 280 of the UE 120, any other component(s) of FIG. 2, the CU 310, the DU 330, or the RU 340 may perform or direct operations of, for example, process 900 of FIG. 9, process 1000 of FIG. 10, or other processes as described herein (alone or in conjunction with one or more other processors). The memory 242 may store data and program codes for the network node 110, the network node 110, the CU 310, the DU 330, or the RU 340. The memory 282 may store data and program codes for the UE 120. In some examples, the memory 242 or the memory 282 may include a non-transitory computer-readable medium storing a set of instructions (for example, code or program code) for wireless communication. The memory 242 may include one or more memories, such as a single memory or multiple different memories (of the same type or of different types). The memory 282 may include one or more memories, such as a single memory or multiple different memories (of the same type or of different types). For example, the set of instructions, when executed (for example, directly, or after compiling, converting, or interpreting) by one or more processors of the network node 110, the UE 120, the CU 310, the DU 330, or the RU 340, may cause the one or more processors to perform process 900 of FIG. 9, process 1000 of FIG. 10, or other processes as described herein. In some examples, executing instructions may include running the instructions, converting the instructions, compiling the instructions, and/or interpreting the instructions, among other examples.

In some aspects, the UE 120 includes means for receiving an indication of a first link direction for an SBFD resource, wherein the indication is via dynamic signaling or configuration information; and/or means for performing a communication in the SBFD resource in association with a conflict between: the first link direction, and a conflicting communication in the SBFD resource having a second link direction different than the first link direction. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for transmitting an indication of a first link direction for an SBFD resource, wherein the indication is via dynamic signaling or configuration information; and/or means for performing a communication in the SBFD resource in association with a conflict between: the first link direction, and a conflicting communication in the SBFD resource having a second link direction different than the first link direction. The means for the network node 110 to perform operations described herein may include, for example, one or more of communication manager 150, transmit processor 214, TX MIMO processor 216, modem 232, antenna 234, MIMO detector 236, receive processor 238, controller/processor 240, memory 242, or scheduler 246.

As indicated above, FIG. 3 is provided as an example. Other examples may differ from what is described with regard to FIG. 3.

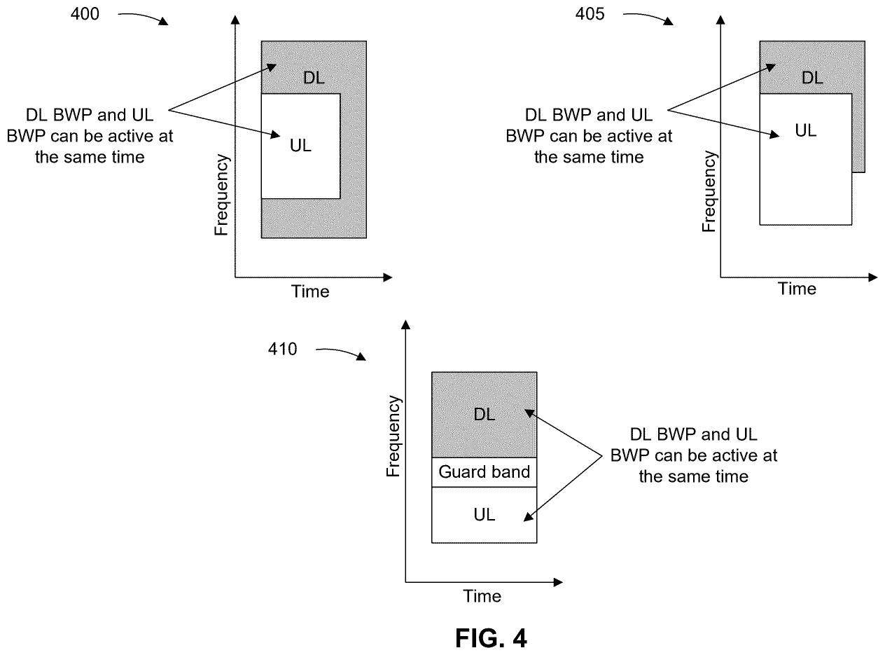

FIG. 4 is a diagram illustrating examples 400, 405, and 410 of full duplex communication in a wireless network, in accordance with the present disclosure. As described herein, “full duplex communication” refers to simultaneous uplink and downlink communication in a wireless network, which may be a capability of a UE, a network node, or another suitable device. For example, a UE operating in a full duplex mode may transmit an uplink communication and receive a downlink communication at the same time (e.g., in the same slot or the same symbol), and a network node operating in a full duplex mode may receive an uplink communication and transmit a downlink communication at the same time. “Half-duplex communication” in a wireless network refers to unidirectional communications (e.g., only downlink communication or only uplink communication) at a given time (e.g., a device only transmits or only receives in a given slot or a given symbol). In some cases, one or more nodes in a wireless network may support full duplex communication and half-duplex communication, and other nodes may support half-duplex communication only. For example, in some aspects, a network node may support full duplex and half-duplex communication, and one or more UEs and/or repeater nodes may support half-duplex communication only.

As shown in FIG. 4, examples 400 and 405 show examples of in-band full duplex (IBFD) communication. In a scenario where a network node supports IBFD and a UE supports half-duplex communication only, the network node may receive an uplink communication from a first UE and may transmit a downlink communication to a second UE on the same time and frequency resources. As shown in example 400, in a first example of IBFD, the time and frequency resources for uplink communication may fully overlap with the time and frequency resources for downlink communication (e.g., all time and frequency resources allocated to uplink communication are also available for downlink communication). As shown in example 405, in a second example of IBFD, the time and frequency resources for uplink communication may partially overlap with the time and frequency resources for downlink communication (e.g., some time and frequency resources are reserved for uplink communication only).

As further shown in FIG. 4, example 410 shows an example of SBFD communication, which may also be referred to as “subband frequency division duplex (SBFDD),” “flexible duplex,” or “FDD in unpaired spectrum.” In some aspects, an SBFD communication mode may be supported by a network node only, by a network node and a UE, by a network node and a repeater node, and/or any suitable combination thereof. In the SBFD communication, a node operating in accordance with an SBFD configuration may simultaneously transmit and receive different communications at the same time, but on different frequency resources. For example, a network node operating in accordance with an SBFD configuration may simultaneously receive an uplink communication from a first UE in an uplink subband and transmit a downlink communication to a second UE in a downlink subband, where the uplink subband and the downlink subband may occupy different frequency resources. Similarly, when a UE supports an SBFD configuration, the UE may transmit an uplink communication to a network node and receive a downlink communication from the network node at the same time, but on different frequency resources. For example, the different frequency resources may be subbands of a frequency band, such as a TDD band. In this case, the frequency resources used for downlink communication may be separated from the frequency resources used for uplink communication, in the frequency domain, by a guard band.

As indicated above, FIG. 4 is provided as an example. Other examples may differ from what is described with regard to FIG. 4.

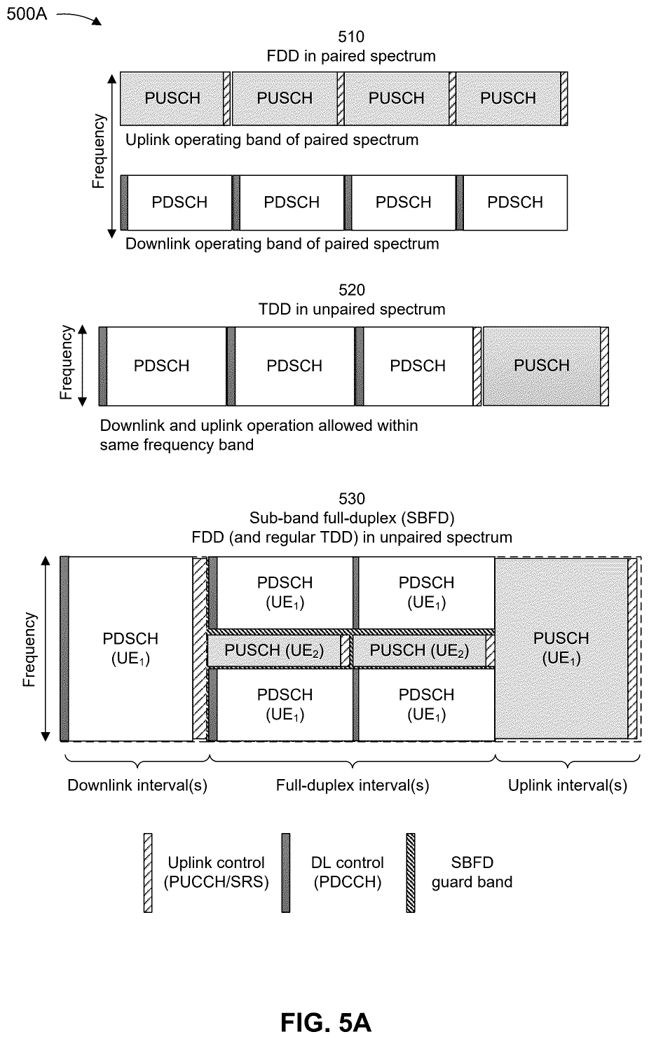

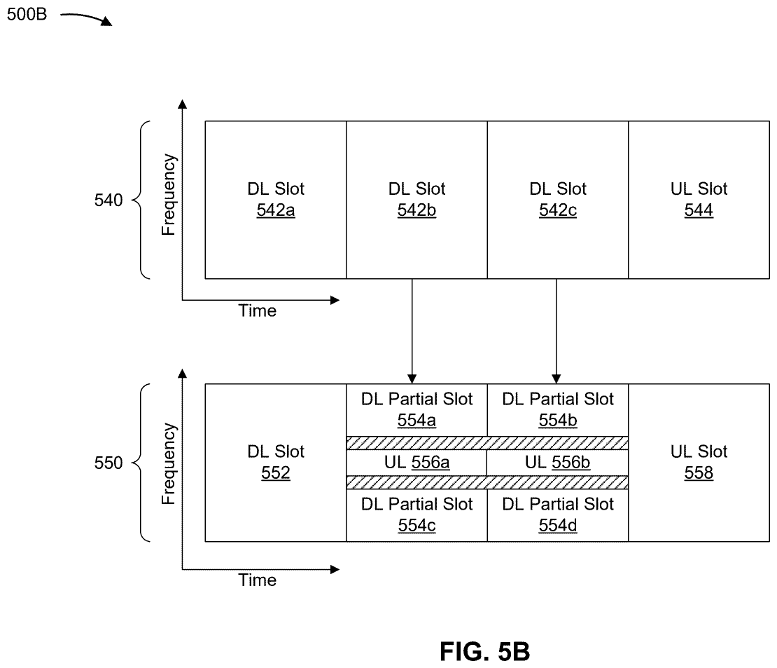

FIG. 5A is a diagram illustrating examples 500A of different duplexing modes, and FIG. 5B is a diagram illustrating an example 500B of SBFD activation, in accordance with the present disclosure. For example, as described in further detail herein, FIG. 5A illustrates an example 510 of an FDD mode that may be used in paired spectrum, an example 520 of a TDD mode that may be used in unpaired spectrum, and an example 530 of an SBFD mode that may be used in unpaired spectrum, and FIG. 5B illustrates an example 500B of techniques that may be used to activate the SBFD mode.

In some aspects, a wireless communication standard and/or governing body may generally specify one or more duplexing modes in which a wireless spectrum is to be used. For example, 3GPP may specify how wireless spectrum is to be used for the 5G/NR radio access technology and interface. As an example, a specification may indicate whether a band is to be used as paired spectrum in an FDD mode or as unpaired spectrum in a TDD mode.

For example, as shown by example 510, paired spectrum in the FDD mode may use a first frequency region (or channel) for uplink communication and a second frequency region (or channel) for downlink communication. In such cases, the frequency regions or channels used for uplink communication and downlink communication do not overlap, have different center frequencies, and have sufficient separation to prevent interference between the downlink communication and the uplink communication. For example, paired spectrum in FDD mode may include an uplink operating band and a downlink operating band that are configured to use non-overlapped frequency regions separated by a guard band. Accordingly, when operating in the FDD mode in paired spectrum, a network node or a UE with full duplex capabilities may perform concurrent transmit and receive operations using the separate operating bands allocated to downlink and uplink communication. For example, paired bands in NR include NR operating bands n1, n2, n3, n5, n7, n8, n12, n20, n25, and n28, as specified by 3GPP Technical Specification (TS) 38.101-1.

As shown by example 520, unpaired spectrum in the TDD mode may allow downlink and uplink operation within a single frequency region (e.g., a single operating band). For example, when operating in TDD mode in unpaired spectrum, downlink communication and uplink communication may occur in the same frequency range. Some deployments may use TDD in the unpaired band, whereby some transmission time intervals (e.g., frames, slots, and/or symbols) are used for downlink communication only and other transmission time intervals are used for uplink communication only. In this case, substantially the entire bandwidth of a component carrier may be used for downlink communication or uplink communication, depending on whether the communication is performed in a downlink interval, an uplink interval, or a special interval (in which either downlink or uplink communication can be scheduled). Examples of unpaired bands include NR operating bands n40, n41, and n50, as specified by 3GPP TS 38.101-1. In some cases, however, using TDD in unpaired spectrum may be inefficient. For example, uplink transmit power may be limited, meaning that UEs may be incapable of transmitting with enough power to efficiently utilize the full bandwidth of an uplink slot. This may be particularly problematic in large cells at the cell edge. Furthermore, using TDD may introduce latency relative to a full duplex scheme in which uplink communications and downlink communications can be performed in the same time interval, because TDD restricts usage of a given transmission time interval to uplink or downlink communication only. Furthermore, using TDD may reduce spectral efficiency and/or reduce throughput by restricting usage of a given transmission time interval to uplink or downlink communication only.

Accordingly, as shown by example 530, an unpaired band may be configured in a full duplexing mode to enable concurrent transmit and receive operations in unpaired spectrum (e.g., a TDD band). For example, in FIG. 5A, example 530 depicts an SBFD mode, which may be referred to herein as full duplexing in a frequency division multiplexing (FDM) mode or using other suitable terminology, in order to enable TDD operation and/or FDD operation in unpaired spectrum. For example, as shown in FIG. 5A, an unpaired band configured in the SBFD mode may associate one or more transmission time intervals with downlink communication only (e.g., “D” slots), one or more transmission time intervals for uplink communication only (e.g., “U” slots), and one or more transmission time intervals for both downlink communication and uplink communication (e.g., “D+U” slots). Each transmission time interval may be associated with a control region, illustrated as a portion of a time interval with a diagonal fill for uplink control (e.g., a PUCCH) or a darker-shaded fill for downlink control (e.g., a PDCCH). Additionally, or alternatively, each time interval may be associated with a data region, which is shown as a PDSCH for downlink frequency regions or a PUSCH for uplink frequency regions.

In some aspects, an unpaired band configured in the SBFD mode may include one or more downlink-only time intervals, one or more uplink-only time intervals, and/or one or more full duplex time intervals (e.g., frames, subframes, slots, and/or symbols, among other examples) that are associated with an FDD configuration. For example, as shown in FIG. 5A, the FDD configuration associated with a full duplex time interval may indicate one or more downlink frequency regions (or subbands) and one or more uplink frequency regions (or subbands) that are separated by a guard band. Accordingly, an FDD configuration may divide an unpaired frequency band (e.g., one or more component carriers of an unpaired band) into uplink frequency regions, downlink frequency regions, and/or other regions (e.g., guard bands and/or the like), which may enable a network node or a UE with full duplex capabilities to perform simultaneous transmit and receive operations during one or more time intervals that are divided into downlink and uplink subbands with a guard band separation to prevent the uplink transmission from causing self-interference with respect to downlink reception.

For example, in a given full duplex time interval, a half-duplexing UE may either transmit using the uplink frequency region or receive in the downlink frequency region (e.g., a UE communicating in a half-duplexing mode may only receive in a downlink frequency region or transmit in an uplink frequency region during the full duplex time intervals). Alternatively, a full duplexing UE may transmit using the uplink frequency region and/or receive in the downlink frequency region. Additionally, or alternatively, a full duplexing network node may transmit a downlink communication to a first UE within the downlink frequency regions(s) and simultaneously receive an uplink communication from a second UE in the uplink frequency region(s). In some aspects, the FDD configuration may identify BWP configurations corresponding to the uplink frequency regions and the downlink frequency regions. For example, a respective BWP may be configured for each uplink frequency region and each downlink frequency region.

Additionally, or alternatively, full duplexing may be enabled in unpaired spectrum in an IBFD mode, which may be referred to herein as full duplexing in a spatial division multiplexing (SDM) mode. For example, in an IBFD or SDM mode, uplink communication may occur on time and frequency resources that fully overlap time and frequency resources allocated to downlink communication (e.g., all of the time and frequency resources available for uplink communication are also available for downlink communication), or time and frequency resources that partially overlap with time and frequency resources available for downlink communication (e.g., some time and frequency resources available for uplink communication are also available for downlink communication and some time and frequency resources available for uplink communication are uplink-only). In general, in the IBFD mode, full duplex communication may be conditional on sufficient beam separation between an uplink beam and a downlink beam (e.g., uplink transmission may be from one antenna panel and downlink reception may be in another antenna panel) in order to minimize self-interference that may occur when a transmitted signal leaks into a receive port and/or when an object in a surrounding environment reflects a transmitted signal back to a receive port (e.g., causing a clutter echo effect).

In some cases, as described herein, one or more frequency regions that support SBFD communication may be configured to dynamically switch between operating in a TDD mode and an SBFD mode. For example, as shown in FIG. 5B, example 500B includes a first configuration 540 (e.g., a legacy or default configuration associated with the TDD mode). In some aspects, the first configuration 540 may indicate a first slot format pattern (sometimes called a TDD pattern) associated with a half-duplex mode (e.g., where each interval is downlink-only or uplink-only). The first slot format pattern may include one or more downlink intervals (e.g., shown as three downlink slots 542a, 542b, and 542c, although each downlink interval may correspond to a downlink symbol or another suitable transmission time interval for downlink communication), one or more flexible intervals (not shown), and/or one or more uplink intervals (e.g., shown as one uplink slot 544, although each uplink interval may correspond to an uplink symbol or another suitable transmission time interval for uplink communication). The first slot format pattern may repeat over time. In some aspects, a network node 110 may indicate the first slot format pattern to a UE 120 using one or more slot format indicators. A slot format indicator, for a slot, may indicate whether the corresponding slot is an uplink slot, a downlink slot, or a flexible slot (e.g., that can be used as an uplink or downlink slot).

A network node 110 may instruct (e.g., using an indication, such as an RRC message, a MAC-CE, or DCI) a UE 120 to switch from the first configuration 540 to a second configuration 550. As an alternative, the UE 120 may indicate to the network node 110 that the UE 120 is switching from the first configuration 540 to the second configuration 550. The second configuration 550 may indicate a second slot format pattern that repeats over time, similar to the first slot format pattern. In any of the aspects described above, the UE 120 may switch from the first configuration 540 to the second configuration 550 during a time period (e.g., a quantity of symbols and/or an amount of time (e.g., in ms)) based at least in part on an indication received from the network node 110 (e.g., before switching back to the first configuration 540). During that time period, the UE 120 may communicate using the second slot format pattern, and then may revert to using the first slot format pattern after the end of the time period. The time period may be indicated by the network node 110 (e.g., in the instruction to switch from the first configuration 540 to the second configuration 550, as described above) and/or based at least in part on a programmed and/or otherwise preconfigured rule. For example, the rule may be based at least in part on a table (e.g., defined in 3GPP specifications and/or another wireless communication standard) that associates different sub-carrier spacings (SCSs) and/or numerologies (e.g., represented by u and associated with corresponding SCSs) with corresponding time periods for switching configurations.

In example 500B, the second slot format pattern includes two SBFD slots in place of what were downlink slots in the first slot format pattern. In example 500B, the second slot format pattern includes a downlink slot 552, which is followed by one or more SBFD slots that each include a partial slot (e.g., a portion or subband of a frequency allocated for use by the network node 110 and the UE 120) for downlink (e.g., partial slots 554a, 554b, 554c, and 554d, as shown) and a partial slot for uplink (e.g., partial slots 556a and 556b, as shown), which are followed by an uplink slot 558. Accordingly, the UE 120 may operate using the second slot format pattern to transmit an uplink communication in an earlier slot (e.g., the second slot in sequence, shown as partial uplink slot 556a) as compared to using the first slot format pattern (e.g., the fourth slot in sequence, shown as uplink slot 544). Other examples may include additional or alternative changes. For example, the second configuration 550 may indicate an SBFD slot in place of what was an uplink slot in the first configuration 540 (e.g., uplink slot 544). In another example, the second configuration 550 may indicate a downlink slot or an uplink slot in place of what was an SBFD slot in the first configuration 540 (not shown in FIG. 5B). In yet another example, the second configuration 550 may indicate a downlink slot or an uplink slot in place of what was an uplink slot or a downlink slot, respectively, in the first configuration 540. An “SBFD slot” may refer to a slot in which an SBFD format is used. An SBFD format may include a slot format in which full duplex communication is supported (e.g., for both uplink and downlink communications), with one or more frequencies used for an uplink portion of the slot being separated from one or more frequencies used for a downlink portion of the slot by a guard band. In some aspects, the SBFD format may include a single uplink portion and a single downlink portion separated by a guard band. In some aspects, the SBFD format may include multiple downlink portions and a single uplink portion that is separated from the multiple downlink portions by respective guard bands (e.g., as shown in FIG. 5B). In some aspects, an SBFD format may include multiple uplink portions and a single downlink portion that is separated from the multiple uplink portions by respective guard bands. In some aspects, the SBFD format may include multiple uplink portions and multiple downlink portions, where each uplink portion is separated from a downlink portion by a guard band. In some aspects, operating using an SBFD mode may include activating or using a full duplex (FD) mode in one or more slots based at least in part on the one or more slots having the SBFD format. A slot may support the SBFD mode if an uplink bandwidth part and a downlink bandwidth part are permitted to be or are simultaneously active in the slot in an SBFD fashion (e.g., with guard band separation).

By switching from the first configuration 540 to the second configuration 550, the network node 110 and the UE 120 may experience increased quality and/or reliability of communications. For example, the network node 110 and the UE 120 may experience increased throughput (e.g., using a full duplex mode), reduced latency (e.g., the UE 120 may be able to transmit an uplink and/or a downlink communication sooner using the second configuration 550 rather than the first configuration 540), and increased network resource utilization (e.g., by using both the downlink bandwidth part and the uplink bandwidth part simultaneously instead of only the downlink bandwidth part or the uplink bandwidth part).

As indicated above, FIGS. 5A and 5B are provided as an example. Other examples may differ from what is described with regard to FIGS. 5A and 5B.

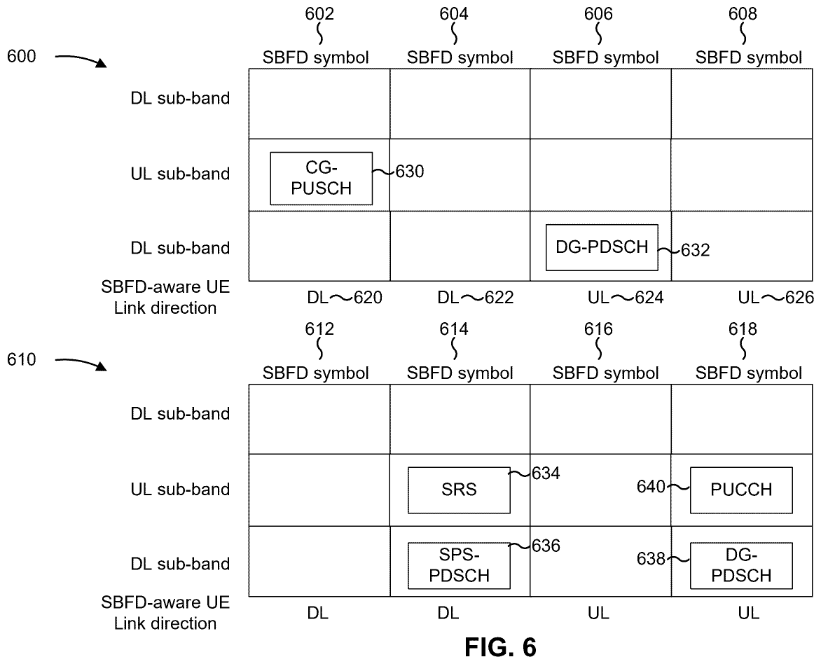

FIG. 6 is a diagram illustrating examples 600 and 610 of SBFD operation and conflicting communications for an SBFD-aware UE, in accordance with the present disclosure. As mentioned above, an SBFD-aware UE may include a UE 120 that is capable of interpreting signaling relating to SBFD operation, and that performs only half-duplex communication.

Example 600 includes a number of SBFD symbols 602, 604, 606, and 608. An SBFD symbol may be referred to herein as an SBFD resource. For example, an SBFD resource may comprise a time-domain resource. Example 610 includes a number of SBFD symbols 612, 614, 616, and 618. The SBFD symbols 602, 604, 606, 608, 612, 614, 616, and 618 of examples 600 and 610 may be included in one or more SBFD slots.

Each SBFD symbol of example 600 and example 610 may be associated with a link direction. A link direction of an SBFD symbol may indicate, for an SBFD-aware UE, a particular link direction in which the SBFD-aware UE is to communicate in the SBFD symbol. As shown by reference number 620, SBFD symbol 602 may be associated with a DL link direction, indicating that an SBFD-aware UE may perform DL communications in SBFD symbol 602. SBFD symbol 612 may also be associated with a DL link direction. As shown by reference number 622, SBFD symbol 604 may be associated with a DL link direction, indicating that an SBFD-aware UE may perform DL communications in SBFD symbol 604. SBFD symbol 614 may also be associated with a DL link direction. As shown by reference number 624, SBFD symbol 606 may be associated with a UL link direction, indicating that an SBFD-aware UE may perform UL communications in SBFD symbol 606. SBFD symbol 614 may also be associated with a UL link direction. As shown by reference number 626, SBFD symbol 608 may be associated with a UL link direction, indicating that an SBFD-aware UE may perform UL communications in SBFD symbol 608. SBFD symbol 618 may also be associated with a DL link direction.

In example 600, a conflicting communication 630 and a conflicting communication 632 are illustrated. In example 610, conflicting communications 634 and 638 are illustrated, as well as other communications 636 and 640. A conflicting communication can be a dynamically scheduled communication (such as a PDSCH communication, an SRS triggering communication, a PUCCH communication, a PUSCH communication, a physical random access channel (PRACH) communication, or a CSI-RS-related communication), a semi-statically configured communication (such as a PDCCH communication, a PDSCH communication, a CSI-RS-related communication, an SRS transmission, an SRS configuration or activation, or a PRACH communication), or a synchronization signal block (SSB) communication. A semi-static communication may be configured via RRC signaling, whereas a dynamically scheduled communication may be scheduled via DCI or other dynamic signaling.

A conflicting communication associated with a first link direction may conflict with another communication or SBFD symbol having a second link direction, if the conflicting communication at least partially overlaps the other communication or SBFD symbol in time, or if the conflicting communication occurs within a threshold length of time of the other communication or SBFD symbol. A conflicting communication May be said to conflict with an SBFD symbol, or with a link direction of the SBFD symbol—these are used interchangeably herein.

As shown, the conflicting communication 630 may be a semi-statically configured UL communication, such as a configured grant (CG) PUSCH communication. The conflicting communication 630 may be considered a conflicting communication (at an SBFD-aware UE) because the conflicting communication 630 has a UL link direction and occurs in an SBFD symbol 602 with a DL link direction (indicated by reference number 620).

As shown, the conflicting communication 632 may be a dynamically scheduled DL communication, such as a dynamic grant (DG) PDSCH communication. The conflicting communication 632 may be considered a conflicting communication (at an SBFD-aware UE) because the conflicting communication 632 has a DL link direction and occurs in an SBFD symbol 606 with a UL link direction (indicated by reference number 626).

The conflicting communication 634 may include a semi-statically configured or dynamically scheduled UL communication, such as an SRS transmission. The other communication 636 may include a semi-statically configured or dynamically configured downlink communication such as an SPS-PDSCH. The conflicting communication 634 may be considered a conflicting communication (at an SBFD-aware UE) because the conflicting communication 634 has a UL link direction and occurs in an SBFD symbol 614 with a DL link direction.

The conflicting communication 638 may include a semi-statically configured or dynamically scheduled DL communication, such as a DG PDSCH communication. The other communication 640 may include a semi-statically configured or dynamically configured UL communication such as a PUCCH. The conflicting communication 638 may be considered a conflicting communication (at an SBFD-aware UE) because the conflicting communication 638 has a DL link direction and occurs in an SBFD symbol 618 with a UL link direction.

Aspects described herein provide determination of the link direction of an SBFD symbol. For example, aspects described herein may provide determination of the link direction of the SBFD symbol in accordance with whether a network node 110 has provided an explicit indication of the link direction of the SBFD symbol. For example, in some aspects, a network node may provide an explicit indication of a link direction via configuration information such as RRC signaling. As another example, in some aspects, the network node may provide the explicit indication of the link direction via dynamic signaling such as DCI. For example, the DCI may include a slot format indicator (SFI) or a similar indication that indicates whether an SBFD symbol has a DL link direction or a UL link direction. In some aspects, the explicit indication may be per SBFD symbol (e.g., may be at the granularity of an SBFD symbol). For example, the explicit indication may include a first indication for an SBFD symbol 602, a second indication for an SBFD symbol 604, a third indication for an SBFD symbol 606, and a fourth indication for an SBFD symbol 608.

In some aspects, if a UE 120 (e.g., an SBFD-aware UE) receives an explicit indication of a link direction for an SBFD symbol, the UE 120 may use the link direction indicated by the explicit indication for the SBFD symbol, thereby enabling network control over link directions and improving flexibility of scheduling or configuration. If the UE 120 does not receive the explicit indication of the link direction, the UE 120 may identify a link direction based on a configured or scheduled transmission or reception and a conflict handling rule.

Examples of conflict handling rules for a case where the UE 120 does not receive the explicit indication of the link direction are now provided. After the description of these conflict handling rules, a description of conflict handling for a case where the UE 120 receives the explicit indication of the link direction is provided.

In a first example of a conflict handling rule for a case where the UE 120 does not receive the explicit indication, when a dynamically scheduled DL reception conflicts with a semi-statically configured uplink transmission, the UE 120 may cancel the semi-statically configured uplink transmission within a cancellation timeline. Thus, the UE 120 may identify the SBFD symbol as having a DL link direction.

In a second example of a conflict handling rule for a case where the UE 120 does not receive the explicit indication, when a semi-statically configured DL reception conflicts with a dynamically scheduled UL transmission, the UE may cancel the semi-statically configured DL reception. Thus, the UE 120 may identify the SBFD symbol as having a UL link direction.

In a third example of a conflict handling rule for a case where the UE 120 does not receive the explicit indication, the UE 120 may not expect a dynamically scheduled DL reception to conflict with a dynamically scheduled UL transmission. For example, the conflict handling rule may indicate to drop DCI that schedules a DL reception that conflicts with a dynamically scheduled UL transmission, or vice versa.

In a fourth example of a conflict handling rule for a case where the UE 120 does not receive the explicit indication, when an SSB reception conflicts with a UL transmission, the UE 120 may receive the SSB, irrespective of whether the UL transmission is a semi-statically configured transmission or a dynamically scheduled transmission. In some aspects, the UE 120 may apply a rule for prioritizing between an SSB and a PRACH occasion, if the SSB conflicts with the PRACH occasion.

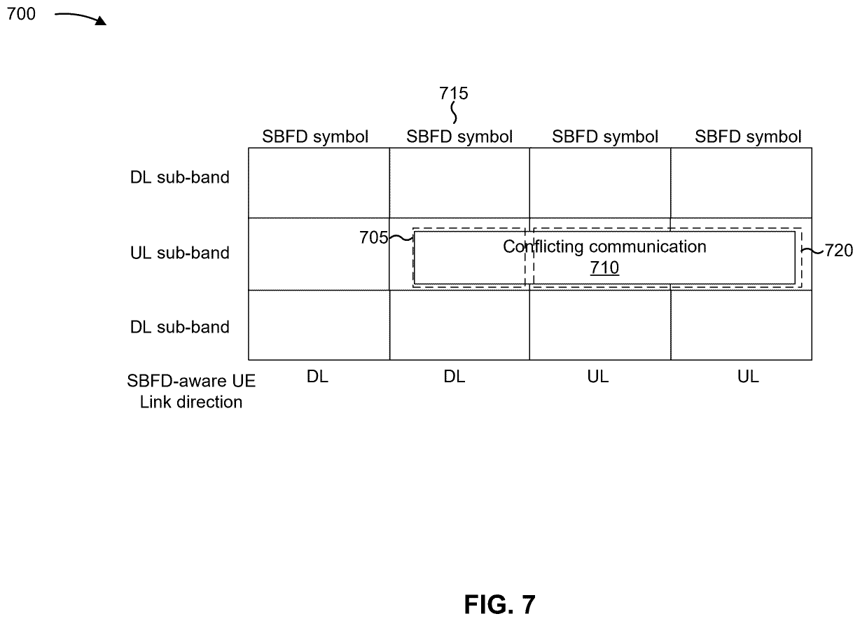

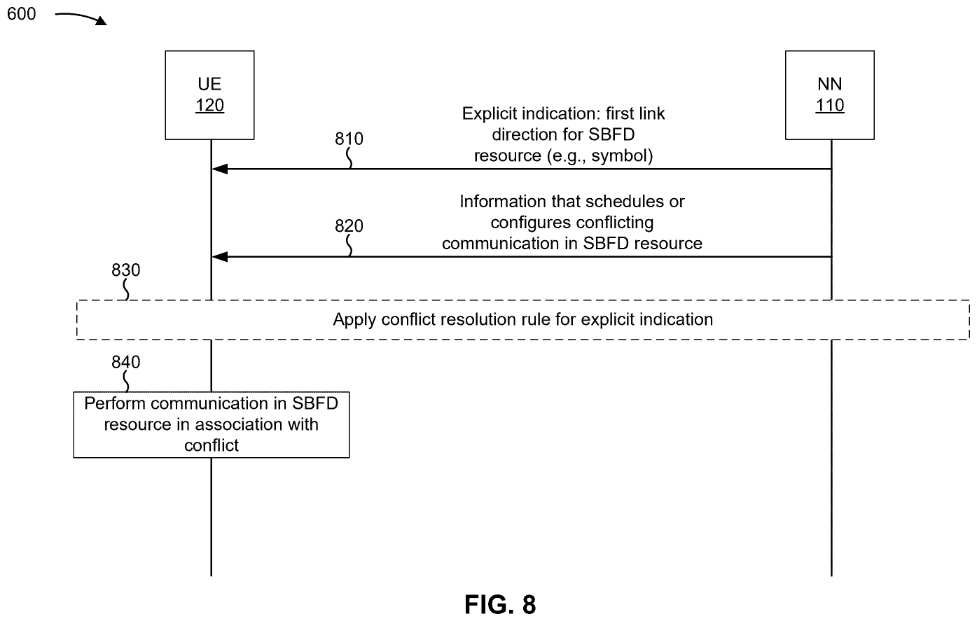

Aspects described herein provide conflict resolution rules for explicit indication, at a network node 110 or a UE 120 such as an SBFD-aware UE, when the UE 120 is provided with an explicit indication of a link direction for one or more SBFD symbols. Examples of conflict resolution rules for explicit indication are provided here and in connection with FIG. 7, and signaling related to the conflict resolution rules for explicit indication is described in connection with FIG. 8.

In some aspects, the UE 120 may receive an explicit indication of a link direction for an SBFD symbol via dynamic signaling or configuration information (e.g., semi-static configuration). The dynamic signaling can be based on unicast (such as UE-dedicated) DCI or group-common DCI for a group of UEs. The configuration information may be received by RRC signaling. The link direction may differ from a link direction of a conflicting communication. For example, the DL link direction of SBFD symbol 602 differs from the UL link direction associated with the conflicting communication 630. As another example, the UL link direction of SBFD symbol 606 differs from the DL link direction associated with the conflicting communication 630. Thus, a conflict may exist between the link direction of the conflicting communication and the link direction of the SBFD symbol. The UE 120 may resolve this conflict according to one or more rules. For example, if the conflicting communication is a semi-statically configured communication (such as a communication configured by a higher layer), the UE 120 may drop the conflicting communication (e.g., may disregard the configuration information for the conflicting communication, may not perform the conflicting communication). As another example, the UE 120 may not expect to receive dynamic signaling (DCI) scheduling a conflicting communication in an SBFD symbol. In some aspects, the network node 110 may avoid dynamic signaling that schedules a conflicting communication. And if received, such dynamic scheduling may be considered as an error case, and the UE 120 may drop the confliction communication. For example, the UE 120 may drop (e.g., cancel, disregard) scheduling information that schedules a conflicting communication in an SBFD symbol. Thus, the UE 120 may drop the conflicting communication 630 or 632, or may drop dynamic signaling that schedules the conflicting communication 630 or 632. In this way, the UE 120 may consider SBFD symbols in a slot indicated as downlink by configuration information (e.g., a dedicated UE configuration) and/or dynamic signaling (e.g., unicast DCI or SFI) to be available only for receptions in the downlink subbands, and may consider SBFD symbols in a slot indicated as uplink by configuration information and/or dynamic signaling to be available only for transmissions in the uplink subbands.

In some aspects, an SBFD symbol (such as SBFD symbol 614 or 618) may have an explicitly indicated first link direction, and the SBFD symbol may include another communication (such as other communication 636 or 640) with the first link direction. The SBFD symbol may also include a conflicting communication (such as conflicting communication 634 or 638) with a second link direction different than the first link direction. In this case, the UE 120 may perform the other communication in a subband that includes the other communication, and may drop (e.g., cancel, not perform, not transmit, not receive) the conflicting communication. For example, if the link direction is a DL link direction, the UE 120 may receive a configured or scheduled DL reception in a DL subband and may drop or cancel a configured or scheduled uplink transmission in the SBFD symbol. As another example, if the link direction is a UL link direction, the UE 120 may transmit a configured or scheduled UL transmission in a UL subband and may drop or cancel a configured or scheduled DL transmission in the SBFD symbol.

FIG. 7 is a diagram illustrating an example 700 of a partial overlap of a conflicting communication and an SBFD symbol, in accordance with the present disclosure. As shown by reference number 705, a conflicting communication 710 (such as conflicting communication 630, 632, 634, or 638) may only partially overlap with an SBFD symbol 715. For example, a first link direction of the SBFD symbol may be different than a second link direction of the conflicting communication 710. Furthermore, a non-overlapped portion 720 of the conflicting communication 710 may be included in SBFD symbols with the second link direction.

In some aspects, a UE 120 may drop (e.g., cancel, not transmit, not receive) an entirety of the conflicting communication 710. For example, the UE 120 may drop the overlapped portion shown by reference number 705 and the non-overlapped portion 720, which may simplify operation at the UE 120. Thus, in some aspects, for a set of SBFD symbols of a slot that are indicated to a UE 120 as downlink by RRC/DCI (such as an SFI), the UE 120 does not transmit a PUSCH, a PUCCH, a PRACH, or an SRS when the PUSCH, the PUCCH, the PRACH, or the SRS overlaps, even partially, with the set of symbols of the slot. Furthermore, in some aspects, for a set of SBFD symbols of a slot that are indicated to a UE 120 as uplink by RRC/DCI (such as SFI), the UE 120 does not receive PDCCH, PDSCH, or CSI-RS when the PDCCH, PDSCH, or CSI-RS overlaps, even partially, with the set of symbols of the slot.

In some aspects, the UE 120 may drop (e.g., cancel, not transmit, not receive) only the overlapped portion shown by reference number 705, and may transmit or receive the non-overlapped portion 720. This may be beneficial for certain types of reference signals, which may still be beneficial when partially transmitted. For example, the conflicting communication 710 may be an SRS that conflicts with a link direction in a subset of SBFD symbols of SRS symbols of the conflicting communication 710, and the UE 120 may only drop the SRS in the SBFD symbols (715) having a conflicting link direction and continue SRS transmission in the remaining symbol(s). When the UE 120 is configured by higher layers or scheduled by DCI to transmit an SRS in a set of symbols and the UE 120 is configured with a conflicting downlink link direction in a subset of symbols from the set of symbols, then the UE 120 may cancel the SRS transmission in the subset of symbols and may not expect to cancel the transmission of SRS in remaining symbols of the set of symbols. In some other examples, when the UE 120 is configured by higher layers or scheduled by DCI to transmit PUCCH, PRACH or PUSCH in a set of symbols and the UE 120 is configured with a conflicting downlink link direction in a subset of symbols from the set of symbols, and when the UE 120 indicates a capability for partial cancellation of a conflicting communication (e.g., a capability partial-Cancellation), the UE 120 may cancel the transmission of the PUCCH or PUSCH or PRACH in the subset of symbols, and the UE 120 may not expect to cancel the transmission of SRS in remaining symbols of the set of symbols.

As indicated above, FIGS. 6 and 7 are provided as examples. Other examples may differ from what is described with regard to FIGS. 6 and 7.

FIG. 8 is a diagram illustrating an example 800 of signaling associated with conflict resolution in SBFD symbols, in accordance with the present disclosure. Example 800 includes a UE 120 and a network node 110. The UE 120 may be an SBFD-aware UE.

As shown, the network node 110 may transmit, and the UE 120 may receive, an indication 810 of a first link direction for an SBFD resource. For example, the UE 120 may receive the indication 810 via configuration information, such as RRC signaling. As another example, the UE 120 may receive the indication 810 via dynamic signaling, such as DCI (e.g., an SFI). In some aspects, as in example 800, the indication 810 may be an explicit indication that indicates a first link direction for one or more SBFD symbols (such as by indicating a link direction specific to an SBFD symbol or by indicating a link direction for an SBFD slot in which the SBFD symbol is included). In some other aspects, as described with regard to FIG. 6, the indication 810 may be an implicit indication, such as scheduling or configuration information for one or more communications in an SBFD symbol.

As shown by reference number 820, the network node 110 may transmit, and the UE 120 may receive, information that schedules or configures a conflicting communication. For example, the conflicting communication may have a second link direction different than the first link direction, representing a conflict between the first link direction (or the SBFD resource) and the conflicting communication. The conflicting communication may occur at least partially in the SBFD resource. For example, the conflicting communication may be included in the SBFD resource, as illustrated with regard to conflicting communications 630, 632, 634, and 638 of FIG. 6. As another example, the conflicting communication may only partially overlap the SBFD resource, as illustrated with regard to conflicting communication 710 of FIG. 7.

As shown, at reference number 830, the UE 120 and/or the network node 110 may apply a conflict resolution rule for an explicit indication. For example, the UE 120 may apply one or more of the conflict resolution rules for explicit indication described with regard to FIG. 6. In this example, the UE 120 may drop at least part of the conflicting communication. For example, the UE 120 may drop an entirety of the conflicting communication. As another example, the UE 120 may drop a portion of the conflicting communication that overlaps the SBFD resource (e.g., only the portion that overlaps the SBFD resource, and potentially any portion included in a threshold length of time from the SBFD resource).

As shown, the UE 120 may perform a communication 840 in the SBFD resource in association with the conflict. For example, the UE 120 may perform the communication 840 after or in accordance with resolving the conflict using the conflict resolution rule for the explicit indication. In some aspects, the communication 840 may be another communication scheduled in the SBFD resource, such as the other communication 636 or the other communication 640. The communication 840 may include a dynamically scheduled communication, a configured communication, or the like. In some aspects, the UE 120 may not perform the communication 840. For example, the UE 120 may drop the conflicting communication without performing another communication in the SBFD resource.

As indicated above, FIG. 8 is provided as an example. Other examples may differ from what is described with regard to FIG. 8.

FIG. 9 is a diagram illustrating an example process 900 performed, for example, at a UE or an apparatus of a UE, in accordance with the present disclosure. Example process 900 is an example where the apparatus or the UE (e.g., UE 120) performs operations associated with conflict resolution for SBFD symbols.

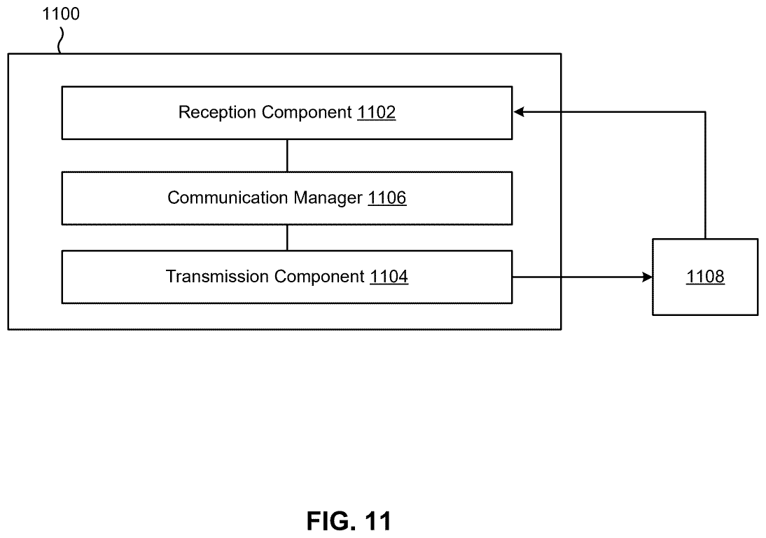

As shown in FIG. 9, in some aspects, process 900 may include receiving an indication of a first link direction for an SBFD resource, wherein the indication is via dynamic signaling or configuration information (block 910). For example, the UE (e.g., using reception component 1102 and/or communication manager 1106, depicted in FIG. 11) may receive an indication (such as indication 810) of a first link direction for an SBFD resource (such as SBFD symbol 602, 604, 606, 608, 612, 614, 616, 618). The indication may be via dynamic signaling or configuration information, as described above with regard to FIG. 8.

As further shown in FIG. 9, in some aspects, process 900 may include performing a communication in the SBFD resource in association with a conflict between: the first link direction, and a conflicting communication in the SBFD resource having a second link direction different than the first link direction (block 920). For example, the UE (e.g., using communication manager 1106, depicted in FIG. 11) may perform a communication in the SBFD resource. The UE may perform the communication in association with a conflict between the first link direction, and a conflicting communication (such as conflicting communication 630, 632, 634, 638, or 710, or the conflicting communication of FIG. 8) in the SBFD resource having a second link direction different than the first link direction, as described above. In some aspects, the UE may perform the communication in association with resolving the conflict, such as according to a conflict resolution rule for explicit indication described with regard to FIGS. 6 and 7. In some aspects, the UE may not perform the communication (e.g., block 920 may be optional). For example, the UE may drop the conflicting communication or disregard DCI that schedules the conflicting communication without performing another communication in the SBFD resource.

Process 900 may include additional aspects, such as any single aspect or any combination of aspects described below and/or in connection with one or more other processes described elsewhere herein.

In a first aspect, receiving the indication comprises receiving an explicit indication of the first link direction for the SBFD resource.

In a second aspect, alone or in combination with the first aspect, performing the communication in the SBFD resource in association with the conflict comprises dropping the conflicting communication in the SBFD resource.

In a third aspect, alone or in combination with one or more of the first and second aspects, performing the communication in the SBFD resource in association with the conflict comprises receiving scheduling information that schedules the conflicting communication in the SBFD resource, and dropping the scheduling information.

In a fourth aspect, alone or in combination with one or more of the first through third aspects, the explicit indication is per SBFD symbol, and the SBFD resource is an SBFD symbol.

In a fifth aspect, alone or in combination with one or more of the first through fourth aspects, the conflicting communication only partially overlaps the SBFD resource, and performing the communication in the SBFD resource in association with the conflict comprises dropping an entirety of the conflicting communication.

In a sixth aspect, alone or in combination with one or more of the first through fifth aspects, the conflicting communication only partially overlaps the SBFD resource, and performing the communication in the SBFD resource in association with the conflict comprises dropping a portion of the conflicting communication.

In a seventh aspect, alone or in combination with one or more of the first through sixth aspects, the portion of the conflicting communication overlaps the SBFD resource.

In an eighth aspect, alone or in combination with one or more of the first through seventh aspects, the communication in the SBFD resource has the first link direction.

In a ninth aspect, alone or in combination with one or more of the first through eighth aspects, the communication overlaps the conflicting communication in time.

In a tenth aspect, alone or in combination with one or more of the first through ninth aspects, the indication schedules or configures at least one of the communication or the conflicting communication in the SBFD resource, and process 900 includes identifying the first link direction in accordance with the indication.

In an eleventh aspect, alone or in combination with one or more of the first through tenth aspects, the first link direction is an uplink direction and the second link direction is a downlink direction.

In a twelfth aspect, alone or in combination with one or more of the first through eleventh aspects, the first link direction is a downlink direction and the second link direction is an uplink direction.

In a thirteenth aspect, alone or in combination with one or more of the first through twelfth aspects, the dynamic signaling comprises downlink control information that indicates the SBFD resource and the first link direction.

In a fourteenth aspect, alone or in combination with one or more of the first through thirteenth aspects, the dynamic signaling comprises radio resource control information that indicates the SBFD resource and the first link direction.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, at a network node or an apparatus of a network node, in accordance with the present disclosure. Example process 1000 is an example where the apparatus or the network node (e.g., network node 110) performs operations associated with conflict resolution for SBFD symbols.

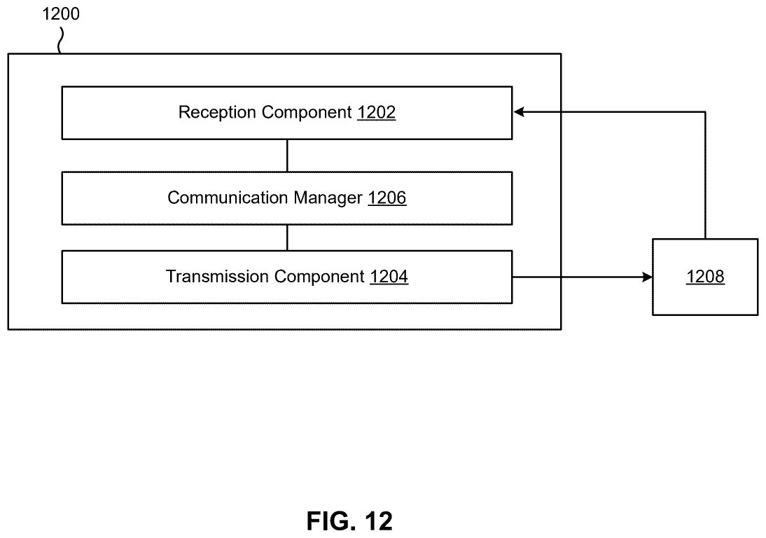

As shown in FIG. 10, in some aspects, process 1000 may include transmitting an indication of a first link direction for a subband full duplex (SBFD) resource, wherein the indication is via dynamic signaling or configuration information (block 1010). For example, the network node (e.g., using transmission component 1204 and/or communication manager 1206, depicted in FIG. 12) may transmit an indication (such as indication 810) of a first link direction for an SBFD resource (such as SBFD symbol 602, 604, 606, 608, 612, 614, 616, 618). The indication may be via dynamic signaling or configuration information, as described above with regard to FIG. 8.

As further shown in FIG. 10, in some aspects, process 1000 may include performing a communication in the SBFD resource in association with a conflict between: the first link direction, and a conflicting communication in the SBFD resource having a second link direction different than the first link direction (block 1020). For example, the network node (e.g., using communication manager 1206, depicted in FIG. 12) may perform a communication in the SBFD resource in association with a conflict between: the first link direction, and a conflicting communication (such as conflicting communication 630, 632, 634, 638, or 710, or the conflicting communication of FIG. 8) in the SBFD resource having a second link direction different than the first link direction, as described above. In some aspects, the network node may perform the communication in association with resolving the conflict, such as according to a conflict resolution rule for explicit indication described with regard to FIGS. 6 and 7.

Process 1000 may include additional aspects, such as any single aspect or any combination of aspects described below and/or in connection with one or more other processes described elsewhere herein.

In a first aspect, transmitting the indication comprises transmitting an explicit indication of the first link direction for the SBFD resource.

In a second aspect, alone or in combination with the first aspect, performing the communication in the SBFD resource in association with the conflict comprises dropping the conflicting communication in the SBFD resource.

In a third aspect, alone or in combination with one or more of the first and second aspects, the explicit indication is per SBFD symbol, and the SBFD resource is an SBFD symbol.

In a fourth aspect, alone or in combination with one or more of the first through third aspects, the conflicting communication only partially overlaps the SBFD resource, and performing the communication in the SBFD resource in association with the conflict comprises dropping an entirety of the conflicting communication.

In a fifth aspect, alone or in combination with one or more of the first through fourth aspects, the conflicting communication only partially overlaps the SBFD resource, and performing the communication in the SBFD resource in association with the conflict comprises dropping a portion of the conflicting communication.

In a sixth aspect, alone or in combination with one or more of the first through fifth aspects, the portion of the conflicting communication overlaps the SBFD resource.

In a seventh aspect, alone or in combination with one or more of the first through sixth aspects, the communication in the SBFD resource has the first link direction.

In an eighth aspect, alone or in combination with one or more of the first through seventh aspects, the communication overlaps the conflicting communication in time.

In a ninth aspect, alone or in combination with one or more of the first through eighth aspects, the first link direction is an uplink direction and the second link direction is a downlink direction.

In a tenth aspect, alone or in combination with one or more of the first through ninth aspects, the first link direction is a downlink direction and the second link direction is an uplink direction.

In an eleventh aspect, alone or in combination with one or more of the first through tenth aspects, the dynamic signaling comprises downlink control information that indicates the SBFD resource and the first link direction.

In a twelfth aspect, alone or in combination with one or more of the first through eleventh aspects, the dynamic signaling comprises radio resource control information that indicates the SBFD resource and the first link direction.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication, in accordance with the present disclosure. The apparatus 1100 may be a UE, or a UE may include the apparatus 1100. In some aspects, the apparatus 1100 includes a reception component 1102, a transmission component 1104, and/or a communication manager 1106, which may be in communication with one another (for example, via one or more buses and/or one or more other components). In some aspects, the communication manager 1106 is the communication manager 140 described in connection with FIG. 1. As shown, the apparatus 1100 may communicate with another apparatus 1108, such as a UE or a network node (such as a CU, a DU, an RU, or a base station), using the reception component 1102 and the transmission component 1104.

In some aspects, the apparatus 1100 may be configured to perform one or more operations described herein in connection with FIGS. 4-8. Additionally, or alternatively, the apparatus 1100 may be configured to perform one or more processes described herein, such as process 900 of FIG. 9, or a combination thereof. In some aspects, the apparatus 1100 and/or one or more components shown in FIG. 11 may include one or more components of the UE described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, one or more modems, one or more demodulators, one or more MIMO detectors, one or more receive processors, one or more controllers/processors, one or more memories, or a combination thereof, of the UE described in connection with FIG. 2.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1108. In some aspects, the transmission component 1104 may include one or more antennas, one or more modems, one or more modulators, one or more transmit MIMO processors, one or more transmit processors, one or more controllers/processors, one or more memories, or a combination thereof, of the UE described in connection with FIG. 2. In some aspects, the transmission component 1104 may be co-located with the reception component 1102 in one or more transceivers.

The communication manager 1106 may support operations of the reception component 1102 and/or the transmission component 1104. For example, the communication manager 1106 may receive information associated with configuring reception of communications by the reception component 1102 and/or transmission of communications by the transmission component 1104. Additionally, or alternatively, the communication manager 1106 may generate and/or provide control information to the reception component 1102 and/or the transmission component 1104 to control reception and/or transmission of communications.

The reception component 1102 may receive an indication of a first link direction for an SBFD resource, wherein the indication is via dynamic signaling or configuration information. The communication manager 1106 may perform a communication in the SBFD resource in association with a conflict between the first link direction, and a conflicting communication in the SBFD resource having a second link direction different than the first link direction.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

FIG. 12 is a diagram of an example apparatus 1200 for wireless communication, in accordance with the present disclosure. The apparatus 1200 may be a network node, or a network node may include the apparatus 1200. In some aspects, the apparatus 1200 includes a reception component 1202, a transmission component 1204, and/or a communication manager 1206, which may be in communication with one another (for example, via one or more buses and/or one or more other components). In some aspects, the communication manager 1206 is the communication manager 150 described in connection with FIG. 1. As shown, the apparatus 1200 may communicate with another apparatus 1208, such as a UE or a network node (such as a CU, a DU, an RU, or a base station), using the reception component 1202 and the transmission component 1204.

In some aspects, the apparatus 1200 may be configured to perform one or more operations described herein in connection with FIGS. 4-8. Additionally, or alternatively, the apparatus 1200 may be configured to perform one or more processes described herein, such as process 1000 of FIG. 10, or a combination thereof. In some aspects, the apparatus 1200 and/or one or more components shown in FIG. 12 may include one or more components of the network node described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1202 may receive communications, such as reference signals, control information, data communications, or a combination thereof, from the apparatus 1208. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, one or more modems, one or more demodulators, one or more MIMO detectors, one or more receive processors, one or more controllers/processors, one or more memories, or a combination thereof, of the network node described in connection with FIG. 2. In some aspects, the reception component 1202 and/or the transmission component 1204 may include or may be included in a network interface. The network interface may be configured to obtain and/or output signals for the apparatus 1200 via one or more communications links, such as a backhaul link, a midhaul link, and/or a fronthaul link.

The transmission component 1204 may transmit communications, such as reference signals, control information, data communications, or a combination thereof, to the apparatus 1208. In some aspects, one or more other components of the apparatus 1200 may generate communications and may provide the generated communications to the transmission component 1204 for transmission to the apparatus 1208. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1208. In some aspects, the transmission component 1204 may include one or more antennas, one or more modems, one or more modulators, one or more transmit MIMO processors, one or more transmit processors, one or more controllers/processors, one or more memories, or a combination thereof, of the network node described in connection with FIG. 2. In some aspects, the transmission component 1204 may be co-located with the reception component 1202 in one or more transceivers.

The communication manager 1206 may support operations of the reception component 1202 and/or the transmission component 1204. For example, the communication manager 1206 may receive information associated with configuring reception of communications by the reception component 1202 and/or transmission of communications by the transmission component 1204. Additionally, or alternatively, the communication manager 1206 may generate and/or provide control information to the reception component 1202 and/or the transmission component 1204 to control reception and/or transmission of communications.

The transmission component 1204 may transmit an indication of a first link direction for an SBFD resource, wherein the indication is via dynamic signaling or configuration information. The communication manager 1206 may perform a communication in the SBFD resource in association with a conflict between the first link direction, and a conflicting communication in the SBFD resource having a second link direction different than the first link direction.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

The following provides an overview of some Aspects of the present disclosure:

Aspect 1: A method of wireless communication performed by a user equipment (UE), comprising: receiving an indication of a first link direction for a subband full duplex (SBFD) resource, wherein the indication is via dynamic signaling or configuration information; and performing a communication in the SBFD resource in association with a conflict between: the first link direction, and a conflicting communication in the SBFD resource having a second link direction different than the first link direction.

Aspect 2: The method of Aspect 1, wherein receiving the indication comprises receiving an explicit indication of the first link direction for the SBFD resource.

Aspect 3: The method of Aspect 2, wherein performing the communication in the SBFD resource in association with the conflict comprises dropping the conflicting communication in the SBFD resource.

Aspect 4: The method of Aspect 2, wherein performing the communication in the SBFD resource in association with the conflict comprises: receiving scheduling information that schedules the conflicting communication in the SBFD resource; and dropping the scheduling information.

Aspect 5: The method of Aspect 2, wherein the explicit indication is per SBFD symbol, and wherein the SBFD resource is an SBFD symbol.

Aspect 6: The method of Aspect 2, wherein the conflicting communication only partially overlaps the SBFD resource, and wherein performing the communication in the SBFD resource in association with the conflict comprises dropping an entirety of the conflicting communication.

Aspect 7: The method of Aspect 2, wherein the conflicting communication only partially overlaps the SBFD resource, and wherein performing the communication in the SBFD resource in association with the conflict comprises dropping a portion of the conflicting communication.

Aspect 8: The method of Aspect 7, wherein the portion of the conflicting communication overlaps the SBFD resource.

Aspect 9: The method of Aspect 2, wherein the communication in the SBFD resource has the first link direction.

Aspect 10: The method of Aspect 9, wherein the communication overlaps the conflicting communication in time.

Aspect 11: The method of any of Aspects 1-10, wherein the indication schedules or configures at least one of the communication or the conflicting communication in the SBFD resource, wherein the method further comprises identifying the first link direction in accordance with the indication.

Aspect 12: The method of any of Aspects 1-11, wherein the first link direction is an uplink direction and the second link direction is a downlink direction.

Aspect 13: The method of any of Aspects 1-12, wherein the first link direction is a downlink direction and the second link direction is an uplink direction.

Aspect 14: The method of any of Aspects 1-13, wherein the dynamic signaling comprises downlink control information that indicates the SBFD resource and the first link direction.

Aspect 15: The method of any of Aspects 1-14, wherein the dynamic signaling comprises radio resource control information that indicates the SBFD resource and the first link direction.

Aspect 16: A method of wireless communication performed by a network node, comprising: transmitting an indication of a first link direction for a subband full duplex (SBFD) resource, wherein the indication is via dynamic signaling or configuration information; and performing a communication in the SBFD resource in association with a conflict between: the first link direction, and a conflicting communication in the SBFD resource having a second link direction different than the first link direction.

Aspect 17: The method of Aspect 16, wherein transmitting the indication comprises transmitting an explicit indication of the first link direction for the SBFD resource.

Aspect 18: The method of Aspect 17, wherein performing the communication in the SBFD resource in association with the conflict comprises dropping the conflicting communication in the SBFD resource.

Aspect 19: The method of Aspect 17, wherein the explicit indication is per SBFD symbol, and wherein the SBFD resource is an SBFD symbol.

Aspect 20: The method of Aspect 17, wherein the conflicting communication only partially overlaps the SBFD resource, and wherein performing the communication in the SBFD resource in association with the conflict comprises dropping an entirety of the conflicting communication.

Aspect 21: The method of Aspect 17, wherein the conflicting communication only partially overlaps the SBFD resource, and wherein performing the communication in the SBFD resource in association with the conflict comprises dropping a portion of the conflicting communication.

Aspect 22: The method of Aspect 21, wherein the portion of the conflicting communication overlaps the SBFD resource.

Aspect 23: The method of Aspect 17, wherein the communication in the SBFD resource has the first link direction.

Aspect 24: The method of Aspect 23, wherein the communication overlaps the conflicting communication in time.

Aspect 25: The method of any of Aspects 16-24, wherein the first link direction is an uplink direction and the second link direction is a downlink direction.

Aspect 26: The method of any of Aspects 16-25, wherein the first link direction is a downlink direction and the second link direction is an uplink direction.

Aspect 27: The method of any of Aspects 16-26, wherein the dynamic signaling comprises downlink control information that indicates the SBFD resource and the first link direction.

Aspect 28: The method of any of Aspects 16-27, wherein the dynamic signaling comprises radio resource control information that indicates the SBFD resource and the first link direction.

Aspect 29: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-28.

Aspect 30: An apparatus for wireless communication at a device, the apparatus comprising one or more memories and one or more processors coupled to the one or more memories, the one or more processors configured to cause the device to perform the method of one or more of Aspects 1-28.

Aspect 31: An apparatus for wireless communication, the apparatus comprising at least one means for performing the method of one or more of Aspects 1-28.

Aspect 32: A non-transitory computer-readable medium storing code for wireless communication, the code comprising instructions executable by one or more processors to perform the method of one or more of Aspects 1-28.

Aspect 33: A non-transitory computer-readable medium storing a set of instructions for wireless communication, the set of instructions comprising one or more instructions that, when executed by one or more processors of a device, cause the device to perform the method of one or more of Aspects 1-28.

Aspect 34: A device for wireless communication, the device comprising a processing system that includes one or more processors and one or more memories coupled with the one or more processors, the processing system configured to cause the device to perform the method of one or more of Aspects 1-28.

Aspect 35: An apparatus for wireless communication at a device, the apparatus comprising one or more memories and one or more processors coupled to the one or more memories, the one or more processors individually or collectively configured to cause the device to perform the method of one or more of Aspects 1-28.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based on or otherwise in association with” unless explicitly stated otherwise. Also, as used herein, the term “or” is intended to be inclusive when used in a series and may be used interchangeably with “and/or,” unless explicitly stated otherwise (for example, if used in combination with “either” or “only one of”). It should be understood that “one or more” is equivalent to “at least one.”

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set.

What is claimed is:

1. An apparatus for wireless communication at a user equipment (UE), comprising:
one or more memories; and
one or more processors, coupled to the one or more memories, configured to cause the UE to:
receive an indication of a first link direction for a subband full duplex (SBFD) resource, wherein the indication is via dynamic signaling or configuration information; and
perform a communication in the SBFD resource in association with a conflict between:
the first link direction, and
a conflicting communication in the SBFD resource having a second link direction different than the first link direction.

2. The apparatus of claim 1, wherein the one or more processors, to cause the UE to receive the indication, are configured to cause the UE to receive an explicit indication of the first link direction for the SBFD resource.

3. The apparatus of claim 2, wherein the one or more processors, to cause the UE to perform the communication in the SBFD resource in association with the conflict, are configured to cause the UE to drop the conflicting communication in the SBFD resource.

4. The apparatus of claim 2, wherein the one or more processors, to cause the UE to perform the communication in the SBFD resource in association with the conflict, are configured to cause the UE to:
receive scheduling information that schedules the conflicting communication in the SBFD resource; and
drop the scheduling information.

5. The apparatus of claim 2, wherein the explicit indication is per SBFD symbol, and wherein the SBFD resource is an SBFD symbol.

6. The apparatus of claim 2, wherein the conflicting communication only partially overlaps the SBFD resource, and wherein performing the communication in the SBFD resource in association with the conflict comprises dropping an entirety of the conflicting communication.

7. The apparatus of claim 2, wherein the conflicting communication only partially overlaps the SBFD resource, and wherein performing the communication in the SBFD resource in association with the conflict comprises dropping a portion of the conflicting communication.

8. The apparatus of claim 7, wherein the portion of the conflicting communication overlaps the SBFD resource.

9. The apparatus of claim 2, wherein the communication in the SBFD resource has the first link direction.

10. The apparatus of claim 9, wherein the communication overlaps the conflicting communication in time.

11. The apparatus of claim 1, wherein the indication schedules or configures at least one of the communication or the conflicting communication in the SBFD resource, wherein the one or more processors are configured to identify the first link direction in accordance with the indication.

12. The apparatus of claim 1, wherein the first link direction is an uplink direction and the second link direction is a downlink direction.

13. The apparatus of claim 1, wherein the first link direction is a downlink direction and the second link direction is an uplink direction.

14. The apparatus of claim 1, wherein the one or more processors are further configured to cause the UE to downlink control information that indicates the SBFD resource and the first link direction.

15. The apparatus of claim 1, wherein the dynamic signaling comprises radio resource control information that indicates the SBFD resource and the first link direction.

16. An apparatus for wireless communication at a network node, comprising:
one or more memories; and
one or more processors, coupled to the one or more memories, configured to cause the network node to:
transmit an indication of a first link direction for a subband full duplex (SBFD) resource, wherein the indication is via dynamic signaling or configuration information; and
perform a communication in the SBFD resource in association with a conflict between:
the first link direction, and
a conflicting communication in the SBFD resource having a second link direction different than the first link direction.

17. The apparatus of claim 16, wherein the one or more processors, to cause the network node to transmit the indication, are configured to cause the network node to transmit an explicit indication of the first link direction for the SBFD resource.

18. The apparatus of claim 17, wherein the one or more processors, to cause the network node to perform the communication in the SBFD resource in association with the conflict, are configured to cause the network node to drop the conflicting communication in the SBFD resource.

19. A method of wireless communication performed by a user equipment (UE), comprising:
receiving an indication of a first link direction for a subband full duplex (SBFD) resource, wherein the indication is via dynamic signaling or configuration information; and
performing a communication in the SBFD resource in association with a conflict between:
the first link direction, and
a conflicting communication in the SBFD resource having a second link direction different than the first link direction.

20. The method of claim 19, wherein receiving the indication comprises receiving an explicit indication of the first link direction for the SBFD resource.
